(19) United States
(12) Patent Application Publication
(10) Pub. No.: US 2022/0092658 A1
(43) Pub. Date: Mar. 24, 2022

(54) System and method for expert service providers to provide one on one chat advice services through unique empowered independent agents to consumers

(71) Applicant: Gopesh Kumar, Pleasanton, CA (US)

(72) Inventor: Gopesh Kumar, Pleasanton, CA (US)

(21) Appl. No.: 17/482,284

(22) Filed: Sep. 22, 2021

Related U.S. Application Data
(60) Provisional application No. 63/081,486, filed on Sep. 22, 2020.

(51) Int. Cl. G06Q 30/06; G06Q 10/10; G06Q 30/00; G06Q 20/12; H04L 29/06; H04L 12/58

(52) U.S. Cl. CPC G06Q 30/0619; G06Q 10/109; G06Q 30/0633; H04L 51/04; G06Q 20/127; H04L 63/083; H04L 65/4015; G06Q 30/016

(57) ABSTRACT

The present invention provides techniques for managing, supporting and empowering Independent Agents to offer a method for enabling expert Service Providers to deliver, and charge for, advice to consumers, by connecting two parties in real time in an online chat. The present invention also provides the method and techniques for expert Service Providers, in turn, to provide their service through a multiplicity of Independent Agent channels without the potential for communication device conflict; thereby ensuring successful connections for consumers.

### SEQUENCE LISTING OR PROGRAM

Not Applicable

### FEDERALLY SPONSORED RESEARCH

Not Applicable

### TECHNICAL FIELD OF THE INVENTION

The present invention relates to techniques for managing, supporting, and empowering Independent Agents to offer a method for enabling expert Service Providers to deliver, and charge for, advice to consumers, by connecting two parties in real time in an online one on one chat. Further, the present invention provides the method and techniques for expert Service Providers, in turn, to provide their service through a multiplicity of Independent Agent channels without potential communication device conflict for consumers.

### BACKGROUND OF THE INVENTION

The World Wide Web is currently a subject of intense and rapidly growing interest. The World Wide Web is composed of interconnected data sources that are accessible to computer Users through data-communication networks such as the Internet. The data available on the World Wide Web has been assembled by private individuals, commercial companies, government agencies, and special interest organizations. Much of this assembled information is organized into Web pages. A Web site is a collection of Web pages (and other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to Users of the World Wide Web through a software program known as a Web server. A network User uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java script code), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a User indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

As increased demand, and the use of technology enter peoples' lives, there exists a great need for people to be able to contact experts and Service Providers easily and quickly on any topic or subject via the Internet. While many companies have web pages and/or telephone support lines, most do not offer the most convenient and integrated way for potential clients to reach them, nor a simple, automated, yet comprehensive method for charging for their services.

There is a need for a system, especially an Internet-based system, which will enable customers to easily and instantly connect to Service Providers from Internet-based icons located in a broad collection of vehicles such as individual websites, website directories, emails, or online advertisement banners, so that these Service Providers can reach and assist these customers with their questions, in return for fair and agreed-upon payment.

Advice services are currently offered through a variety of methods and techniques utilizing the telephone and/or the Internet. A consumer seeking advice on any number of assorted topics can search in a telephone book's yellow pages, for example, and make a basic telephone call. But advice service providers are not able to effectively or efficiently charge time-based fees for their service in this model, nor are consumers guaranteed that the service provider will be available. Further, Internet searching is steadily replacing traditional yellow pages searches by consumers.

1-900 phone systems do enable service providers to charge for their services on a time-elapsed model. However, 1-900 systems also are not able to take advantage of the massive trend of consumers increasingly using the Internet to search for what they want and need, including advice on assorted topics. Further, single 1-900 numbers have restricted scope and flexibility with regard to service and price, as well as limited consumer trust with regards to billing and quality of service provided.

Currently, there are systems available that facilitate the delivery of advice to consumers in real-time via the Internet utilizing telecommunications systems. However, such systems have created such a massive directory with thousands upon thousands of individual listings in any given category that it has become overwhelming for consumers to determine their choice. Likewise, it has become near impossible for the large majority of individual service providers to attract any interested consumers, as the rigid nature of the directory listing system allows extremely limited opportunities for a particular service provider to differentiate their service among the thousands of others in the same list.

Consequently, there is a need for a system to enable the provision of advice service through both the Internet and telecommunications that can overcome all of the limitations described above. Such a system, which empowers and utilizes independent Agents within its inventive framework and creative methods, is hereinafter described.

### Definitions

Agent: one who integrates and employs the System within their websites or other Internet-based displayed and/or published materials offering a unique, differentiated grouping of Service Providers who collectively employ the System.

Browser: a software program that runs on a client host and is used to request Web pages and other data from server hosts. This data can be downloaded to the client's disk or displayed on the screen by the browser.

Chat: real-time, synchronous, text-based communication via computer or electronic device.

Client host: a computer that requests Web pages from server hosts and communicates through a browser program.

Content provider: a person responsible for providing the information that makes up a collection of Web pages.

Electronic notification: any automated communication received by e-mail, phone, fax, text message, SMS, RSS or any third party software notification or alerting system.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

Internet-Based Icon: a graphical or text icon that is linked to this system's database and enables the initiation of contact between the Service Provider and the consumer, which is located anywhere throughout the Internet including but not limited to websites, emails, directory listings, and advertisement banners

IP (Internet Protocol): the communication protocol governing the Internet.

Server host: a computer on the Internet that hands out Web pages through a Web server program.

Service Provider: one who is providing advice through this system to Users or consumers. Also known as an Expert or an Advisor.

URL (Uniform Resource Locator): the address of a Web component or other data. The URL identifies the protocol used to communicate with the server host, the IP address of the server host, and the location of the requested data on the server host.

User: one who is seeking advice services from expert Service Providers through this system. Also known as a Consumer or Customer.

UWU server: in connection with the present invention, a special Web server in charge of distributing statistics describing Web traffic.

Video Chat: real-time, synchronous, video-based communication via computer or electronic device.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### SUMMARY OF THE INVENTION

The current invention utilizes the Internet. The Internet comprises a vast number of computers and computer networks that are interconnected through communication links. The interconnected computers exchange information using numerous services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

It is the objective of the current invention to provide a system and methods for managing, supporting and empowering independent Agents to offer a unique platform around a standard apparatus for enabling expert Service Providers to deliver, and charge for, advice to consumers, by connecting two parties in real time in an online chat. The present invention remedies the shortcomings of the prior art by enabling group Agents to integrate the system into their own specialized websites, thereby allowing a much greater expression of differentiation for Service Providers and more focused, comprehensible listings for consumers.

The present invention provides the method and techniques to empower expert Service Providers, in turn, to provide their service through an unlimited number of independent Agent channels without potential communication device conflict, thereby maintaining both service provider and consumer satisfaction.

The benefits of this invention include the facilitation of real-time communication between a Consumer and Service Provider of advice, the management of the accounting system for Consumer, Agent and Service Provider, the empowerment of Agents to develop their own customized website that integrates and utilizes the system thereby offering Consumers more focused and differentiated choice online, and the ability for Service Providers to offer their expert services via multiple accounts to numerous independent Agents by eliminating any potential for telecommunication device conflict.

The system provides a more efficient practical and functional method to enable Users to contact Service Providers for expert advice and Service Providers to promote and offer their services to and transact their services with consumers than the current art.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an overview of how a User accesses the system through the Internet;

FIG. 2 shows the systems main login web page;

FIG. 3 shows the listing of Service Providers;

FIGS. 4a and 4b displays a popup displaying the Service Provider's status;

FIG. 5 shows a popup displaying the chat-time time clock;

FIG. 6 displays a popup displaying a User's allotted chat-time;

FIG. 7 User Chat Service Search for Service Provider Links is shown;

FIG. 8 User Chat Service Search for Service Provider Links Search Result is shown;

FIGS. 9 and 10 show the flowchart if a Service Provider is available;

FIG. 11 shows the flowchart if a Service Provider is unavailable;

FIG. 12 displays User's usage information;

FIG. 13 displays Service Provider's usage information;

FIG. 14 displays the association of multiple Service Providers with an Agent;

FIG. 15 displays a summary page associated with an Agent;

FIG. 16 displays an Agent-specific Advisors Information and Management Page;

FIG. 17 displays an Agent-specific window for enabling/disabling the chat feature for an Advisor;

FIG. 18 displays an accounting summary screen for a Service Provider's Transactions page;

FIG. 19 displays an accounting summary screen for a User's Member Transactions page;

FIG. 20 shows the Service Provider Profile in Member Area;

FIG. 21 displays a Chat Usage Transaction for an Agent page associated with an Agent;

FIG. 22 shows and Service Provider Receiving Invite in Chat Screen;

FIG. 23 shows a Service Provider Chat where the invitation is accepted, and chat had begun free;

FIG. 24 shows a Service Provider Chat where the invitation is accepted, and the paid chat has begun;

FIG. 25 shows a Chat Finished Screen;

FIG. 26 shows a Chat Back Request;

FIG. 27 shows the Users interface to Edit a Chat back Request;

FIG. 28 shows the Chat back Requests Member Interface;

FIG. 29 shows the Service Provider Member Chat Back Request review screen; and

FIG. 30 shows a Default Member login page Users Service Provider List.

FIG. 31 shows a chat service login page

FIG. 32 shows an after chat login video popup page.

FIG. 33 shows an advisor after chat login granting video permission.

FIG. 34 shows an advisor after permission video review.

FIG. 35 shows and advisor video login message.

FIG. 36 shows and advisor call now service page.

FIG. 37 shows and advisor video service page.

FIG. 38 shows a user chat login page from a video button.

FIG. 39 shows a user after login video invite message.

FIG. 40 shows a user after clicking invite video popup page.

FIG. 41 shows a user after invite granting video per mission page.

FIG. 42 shows a user after invite video view.

FIG. 43 shows as user chat screen after invitation message sent page.

FIG. 44 shows an advisor with video invitation page.

FIG. 45 shows a video chat in progress.

FIG. 46 shows a video chat in process screen share.

FIG. 47 shows a video chat in progress expanded view.

FIG. 48 shows a video chat in progress screen share icon.

FIG. 49 shows an Agent's Manage Advisor page to enable an advisor for Video and V-Only.

### DETAILED DESCRIPTION OF THE INVENTION

The following description is demonstrative in nature and is not intended to limit the scope of the invention or its application of uses. There are a number of significant design features and improvements incorporated within the invention. The current invention is a system that will allow Users to contact Service Providers in specific fields. The Users will choose a Service Provider to contact. Once a Service Provider is chosen, a pop-up window will appear notifying that User, among other things, if the Service Provider is available or not. If the Service Provider is available, the system will connect the User with the Service Provider upon a user Initiated Chat Invitation Request. If the service provider is unavailable the system will allow the User to schedule a chat or submit a chat back request, which then creates an email notification to the Service Provider notifying the Service Provider a User would like to chat.

The system provides techniques for managing, supporting and empowering Independent Agents to offer a method for enabling expert Service Providers to deliver, and charge for, advice to consumers, by connecting two parties in real time in an online chat. Further, the present invention provides the method and techniques for expert Service Providers, in turn, to provide their service through a multiplicity of Independent Agent channels without potential communication device conflict for consumers.

The computer application that includes the User interface for this invention will henceforth be referred to as “the System” 1. The system 1 is network based and works on an Internet, Intranet and/or Wireless network.

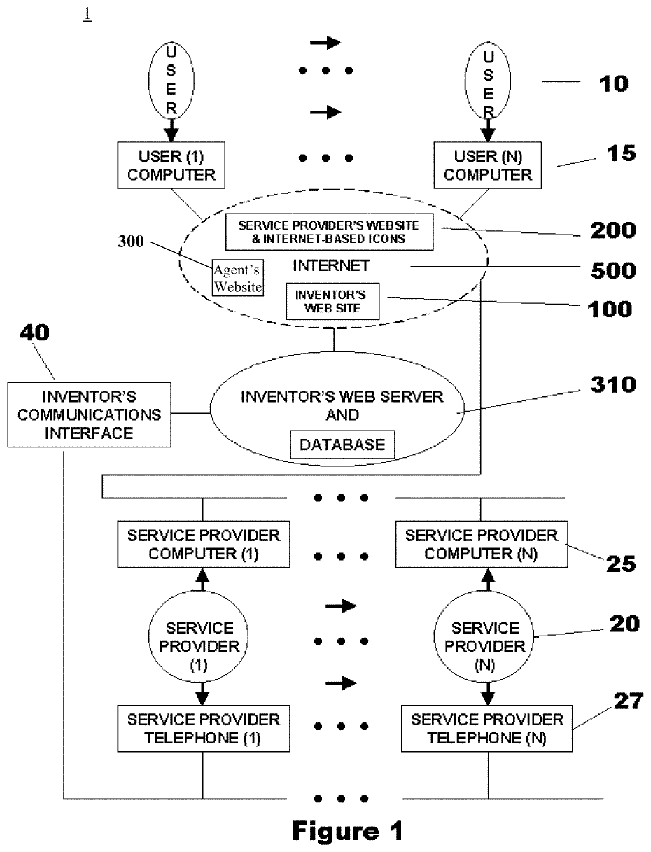

FIG. 1 illustrates a functional diagram of a computer network for World Wide Web 500 access to the System 1 from a plurality of Users 10 who access the System Web Server and Database 310 via the System Web Site 100, independent Agent integrator Websites, and/or a plurality of Service Provider Websites and Internet-based Icons 200 from the Users' Computers 15 and Telephones 27. Accessing the System Web Site 100, the Agent websites 300 or the Service Provider Websites and Internet-based Icons 200 can be accomplished directly through a communication means such as a direct connection, an intranet, a local Internet Service Provider, often referred to as ISPs, or through an on-line Service Provider like AT&T or VERIZON.

The Users 10 contact the System Web Server and Database 310 via the System Web Site 100, the Agent website 300 or the Service Provider Websites and Internet-base Icons 200 using an informational processing system (Client) capable of running an HTML compliant Web browser such as MICROSOFT'S INTERNET EXPLORER, NETSCAPE NAVIGATOR and MOSAIC. A typical system that is used is a personal computer with an operating system such as MAC, LINUX, WINDOWS, or XP, NT, or VISTA, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10, Agents and Service Providers 20 can connect to the System Web Site 100 via the Internet 500 using their respective Computers 15 and 25 to register their accounts. In the preferred embodiment the system has numerous web pages. The information in the web pages is in HTML format via the HyperText Transport Protocol (http) and on Server System 310. The User System 310 allows the viewing of web pages and the inputting of User 10, Agent and Service Provider 20 information to be stored in the System Database 310, through commonly used software referred to as a Web Browser, such as COMMUNICATOR available from NETSCAPE COMMUNICATIONS CORP. or INTERNET EXPLORER available from MICROSOFT CORP. The system is capable of accessing web pages located on Server System 310.

The System Database 310 provides the ability to allow Agents and Service Providers 20 to embed Internet-based Icons within their websites, emails and online advertising banners that are empowered to access the System Web Server Database 310. From these websites and Internet-Based Icons, Users 10 are enabled to contact the Agents' Service Providers or independent Service Providers 20.

The System 1 will connect the User 10 and the Service Provider 20 using a communication interface 40. In the preferred embodiment, once a User 10 decides on a Service Provider 20, the communication interface 40 will call both the User 10 and the Service Provider 20 to connect them so that the Service Provider 20 can assist the User 10. The communication interface 40 will create a chat session over the Internet.

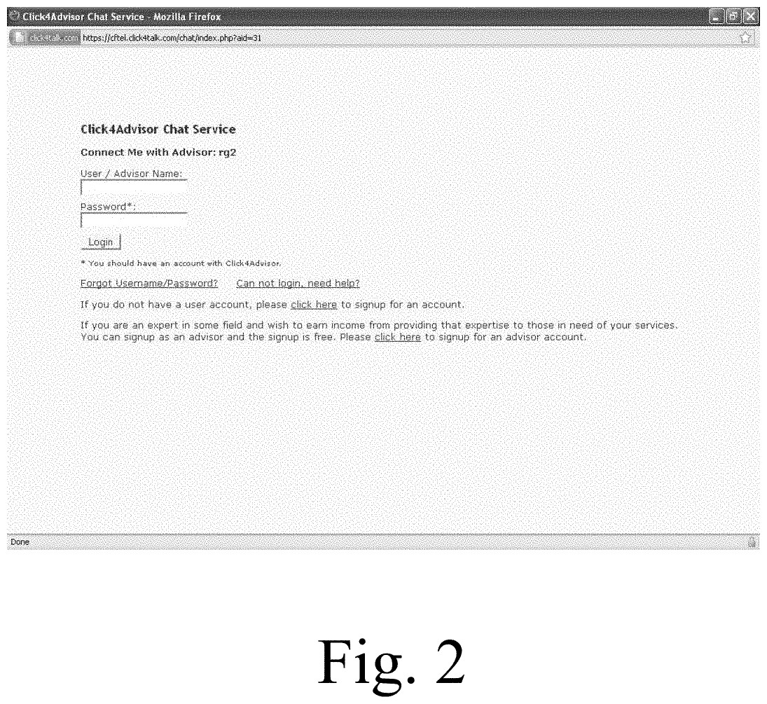

In one preferred embodiment of the invention, the Users 10 connect to the Web site 100. The system 1 would have a standard home web page as shown in FIG. 2. This home web page would have information about the system 1. The main web page in the preferred embodiment would also have an icon that a User 10 would click for a demonstration of the system 1 as well as hypertexts to help and information web pages. The main web page would also include icons that would transfer a User 10 to User Information, Service Provider Information, Agent Information, User Registration, Service Provider Registration, About Us, News and Contact Us web pages. The home web page would also have hypertext to the standard home, legal notices, copyright notices, Privacy Policy, User Agreement, Service Provider Agreement and Contact Us web pages.

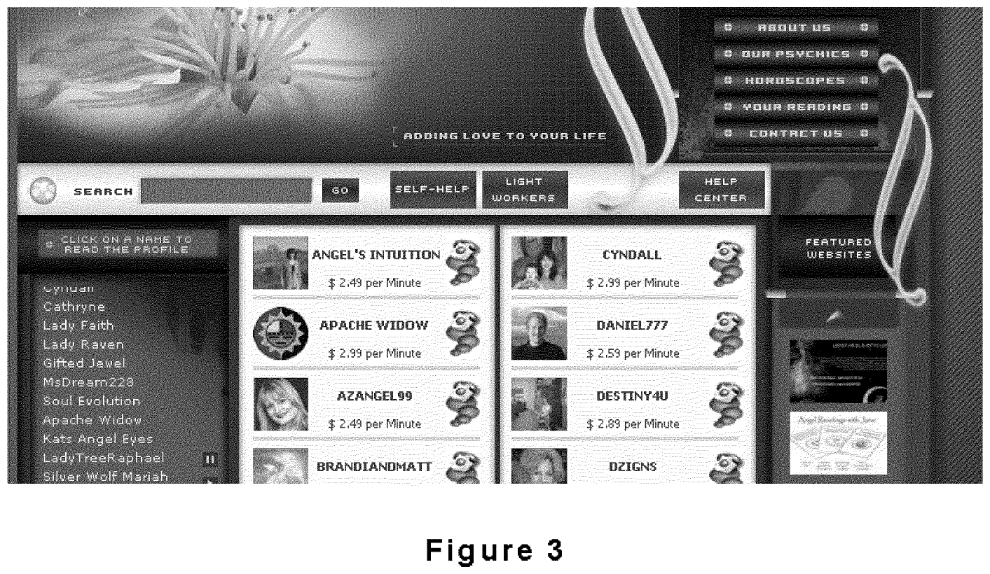

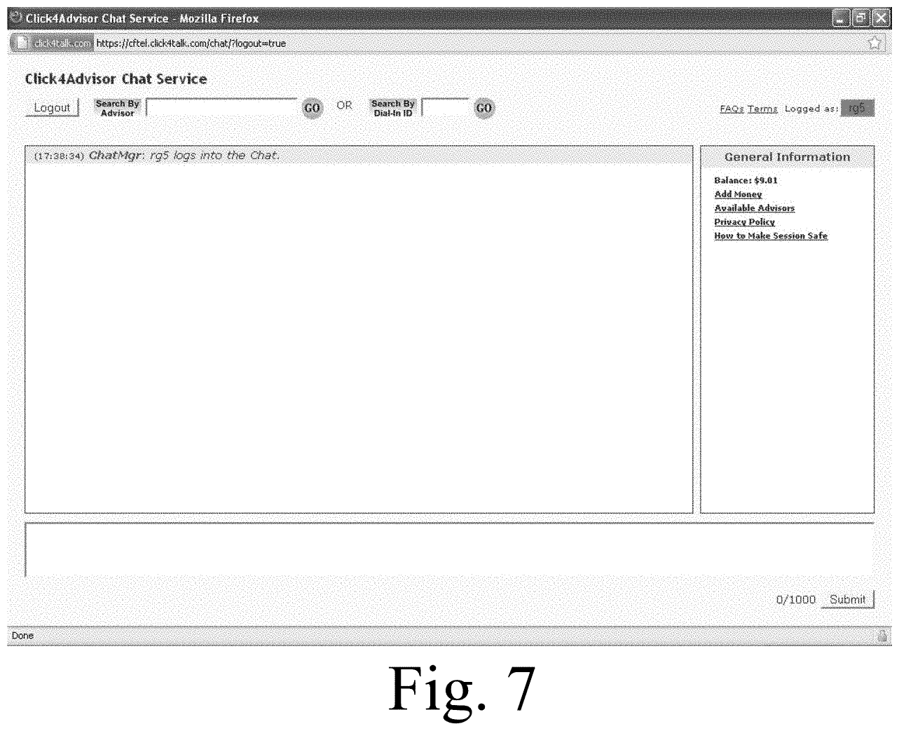

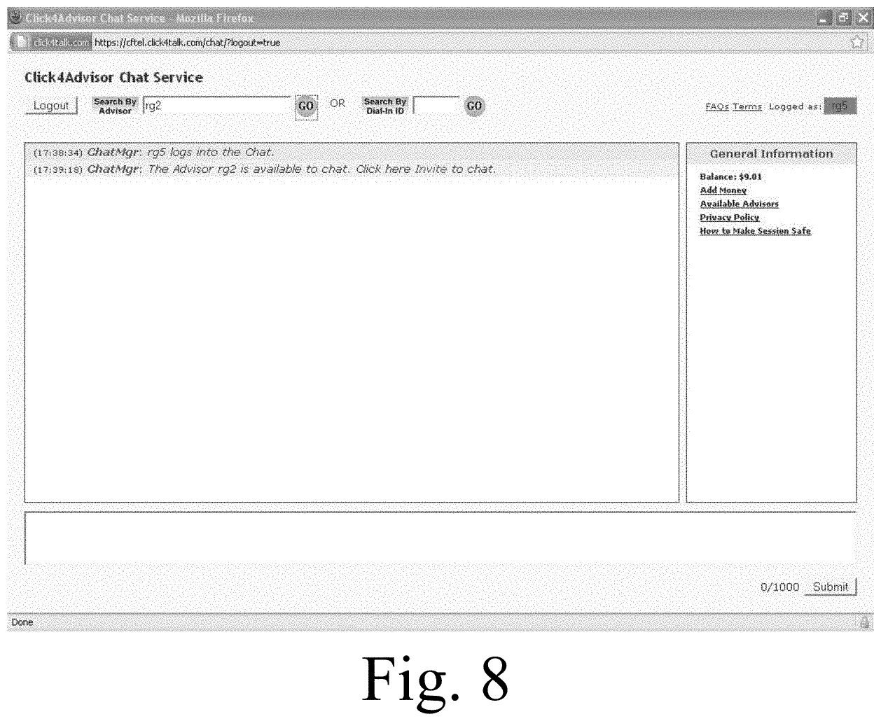

In the preferred embodiment of the System 1, an Agent of the System 1 will provide an industry-specific Internet-based Agent directory website 300, like the example in FIG. 3, where a User 10 can locate and choose from multiple Service Providers 20. If User 10 chooses to use a specific Service Provider, he/she will use the curser to click the connect icon. Alternatively, a User 10 can search an Agent's database for a Service Provider by name or dial-In ID number as shown in FIGS. 7 and 8.

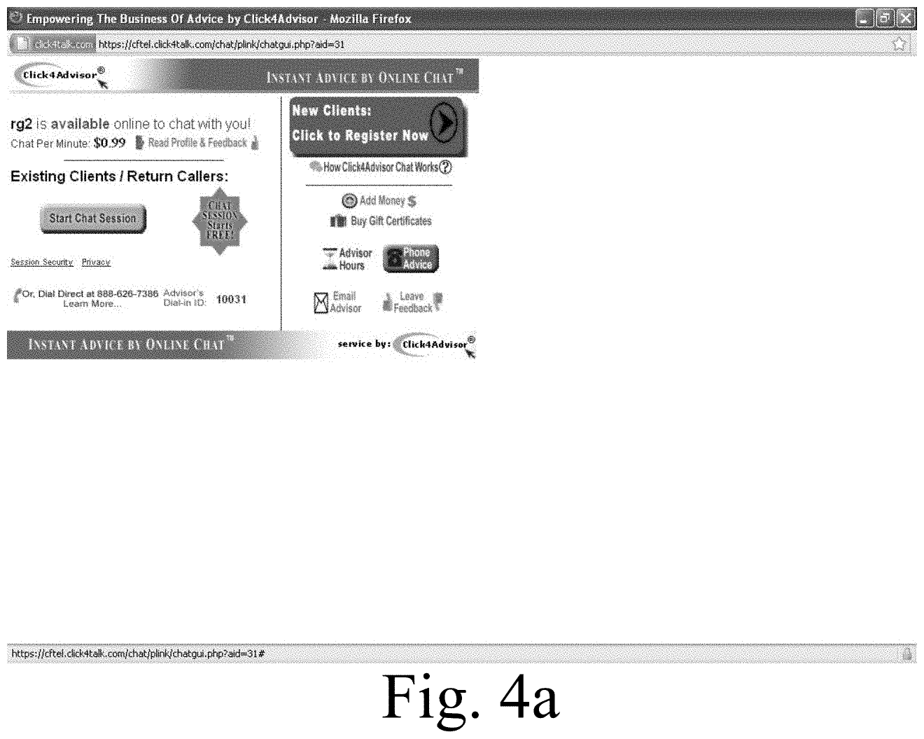

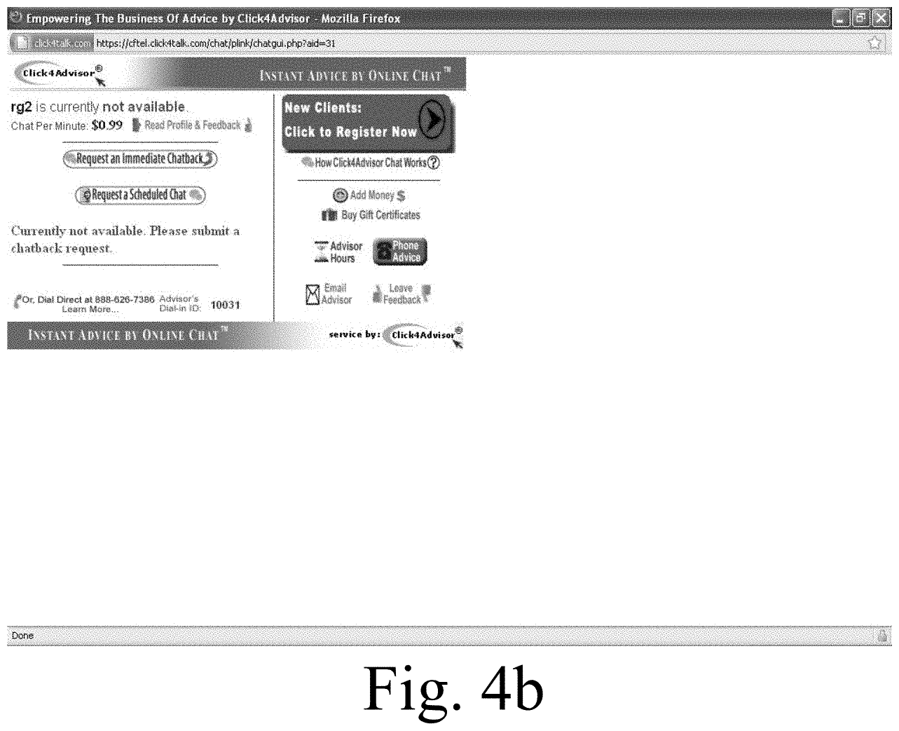

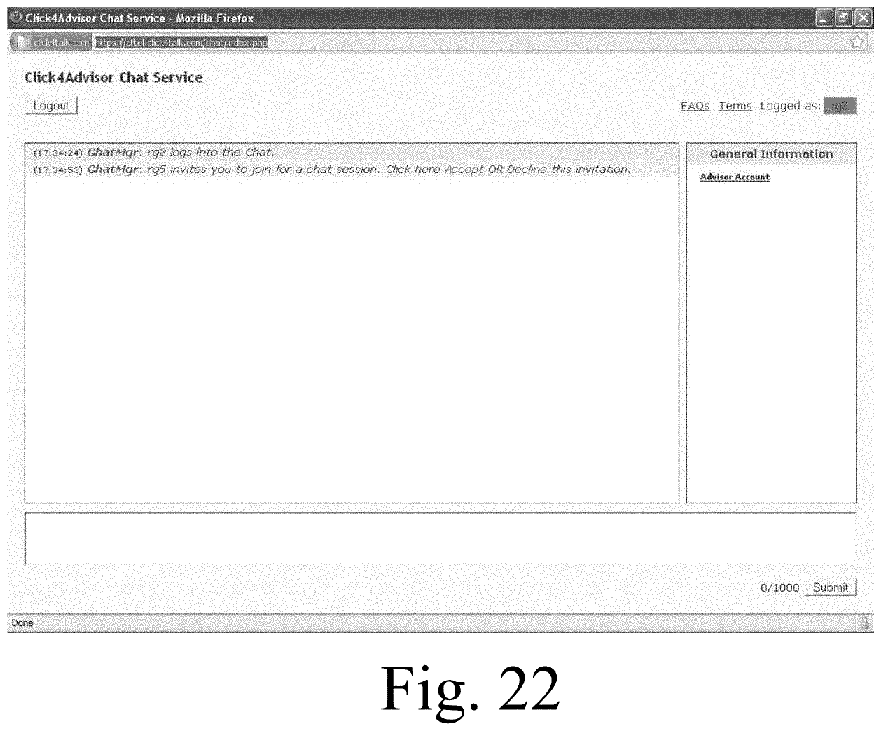

The connect icon will bring up a popup window as shown in FIGS. 4a and 4b. This popup window will display the Service Provider's system ID name, their rate of compensation, a hypertext link to a summary about the Service Provider that includes feedback from previous Users, various other hypertext links to policies, new User Registration, and descriptions of how the System 1 works, as well as text boxes for Users 10 to enter their System ID and Password and telephone number, and whether or not the Service Provider is available. If available as shown in FIG. 4a, the User 10 can send chat invitation request. If unavailable as shown in FIG. 4b, the User 10 can submit an immediate chat back request or send a request to schedule a chat by selecting the appropriate icon. If a chat invitation request is requested by a User and accepted by the Service Provider, the system will then contact the User 10 and the Service Provider by opening an online chat session. FIG. 22 shows a Service Provider 20 receiving an invitation to accept a chat request.

The system 1 will also allow the User 10 to click on hypertext link in an Agent's web property 300 and view a quick list to check the availability status of all the Agent's Service Providers 20.

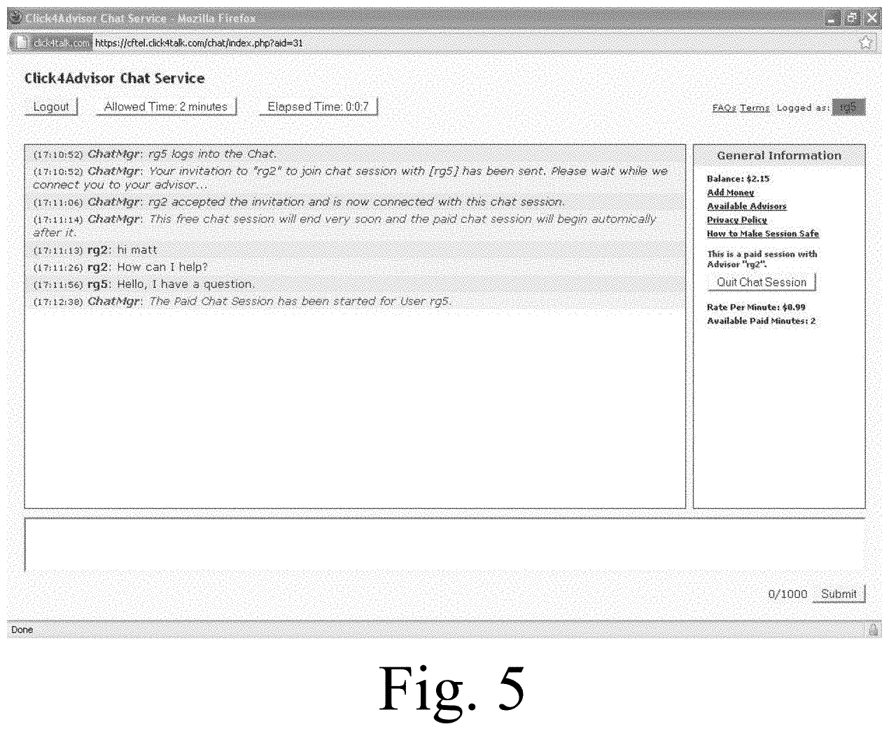

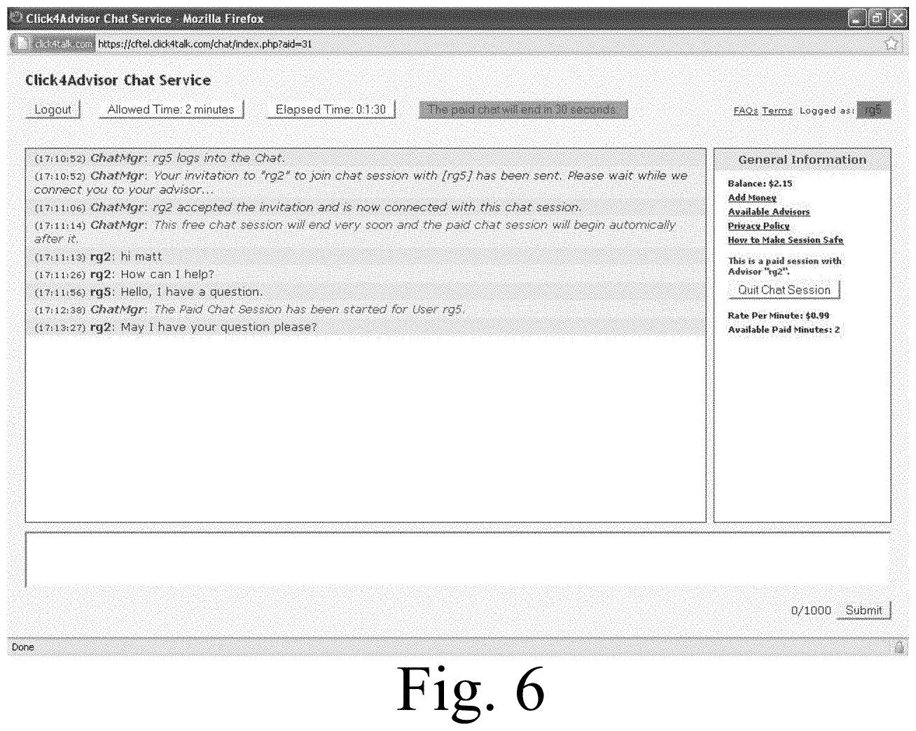

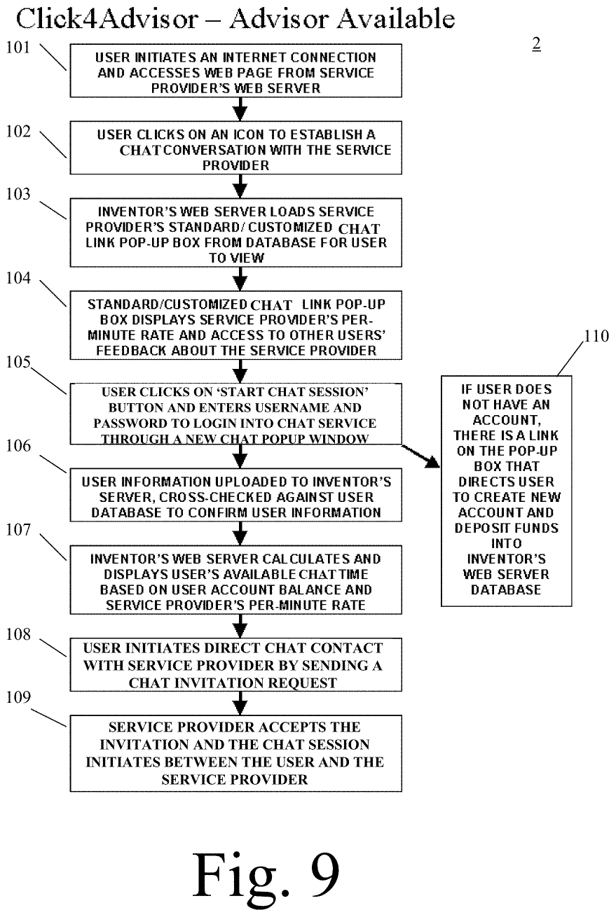

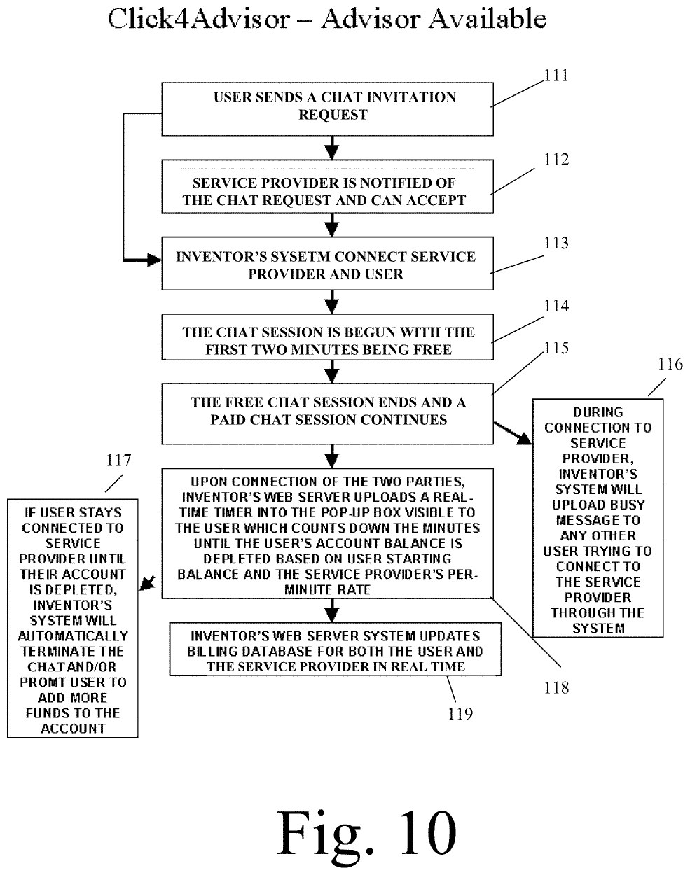

FIG. 9 display a system flowchart 2 of what happens if a Service Provider 20 is Available, and a chat back request is sent from a User 10 to a Service Provider 20. First the User 10 initiates an Internet connection and accesses the Agent's website 300 or the independent Service Provider's web page or other web presence 200 from a web server in step 101. Next the User 10 clicks on an icon to initiate the establishment of an online chat conversation with the Service Provider in step 102. The system's web server 310 loads Service Provider's standard/customized link pop-up box from system database 310 for the User 10 to view in step 103. The standard/customized chat link pop-up window displays the Service Provider's system name, per-minute rate, availability message and access to system email service and to other Users' feedback about the Service Provider in step 104. The User clicks on ‘Start Chat Session” button and the new pop-up window prompts User to enter ID and password to log into chat service in step 105. If User 10 does not have an account, there is a link on the pop-up window that directs User 10 to create a new account and deposit funds into the system's web server database 310 in step 110. The User information is uploaded to the system and crosschecked against the User database to confirm User information in step 106. The system's web server 310 then calculates and displays, as shown in FIGS. 5 and 6, in the chat session pop-up window the User's available talk time based on User account balance and Service Provider's per-minute rate in step 107. The User 10 initiates a direct online chat with the Service Provider 20 by sending a chat invitation request in step 108. The Service Provider accepts the chat invitation, and the chat session initiates between the User and the Service Provider by the system's Communications Interface 40 in step 109.

During the connection to the Service Provider 20, the system 1 will upload a busy message into the pop-up window to any other User 10 trying to connect to the Service Provider 20 through the system 1. Furthermore, the system 1 will upload a busy message into the pop-up window to display to any other User 10 trying to connect to all other Service Provider accounts, either associated with other Agent groups or independent.

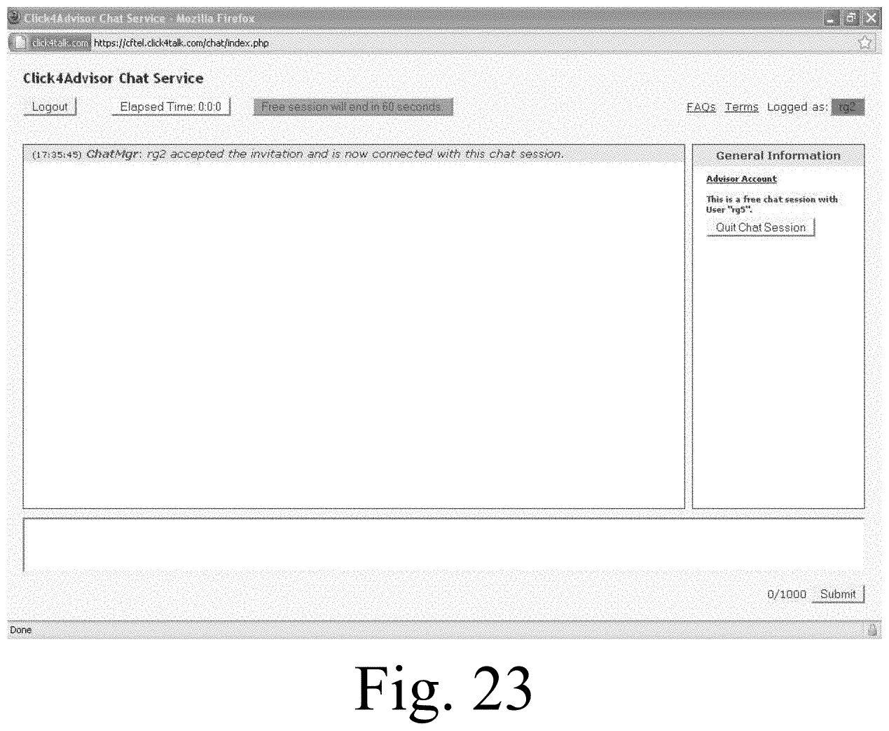

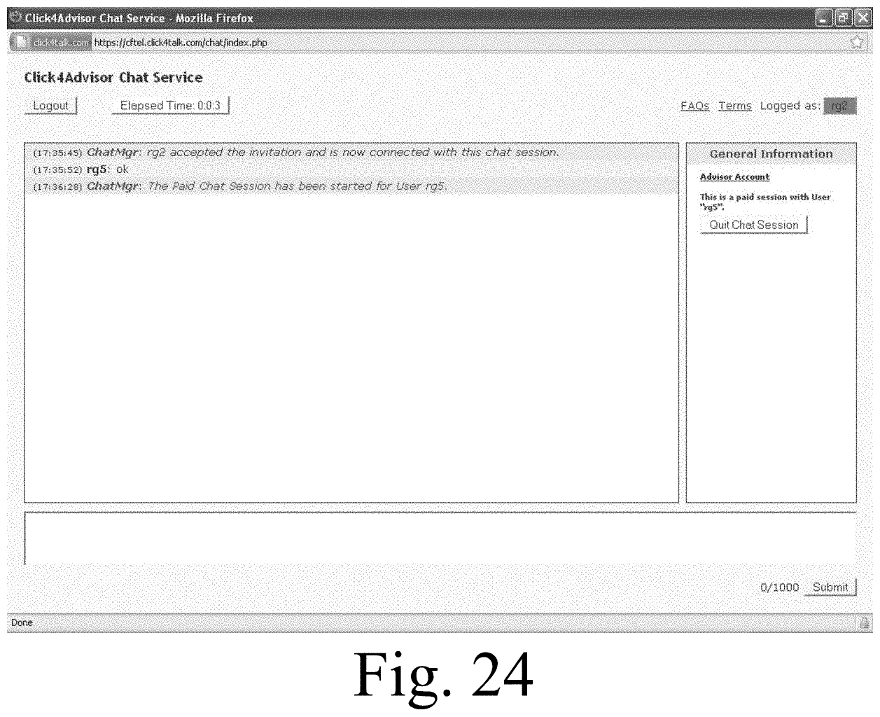

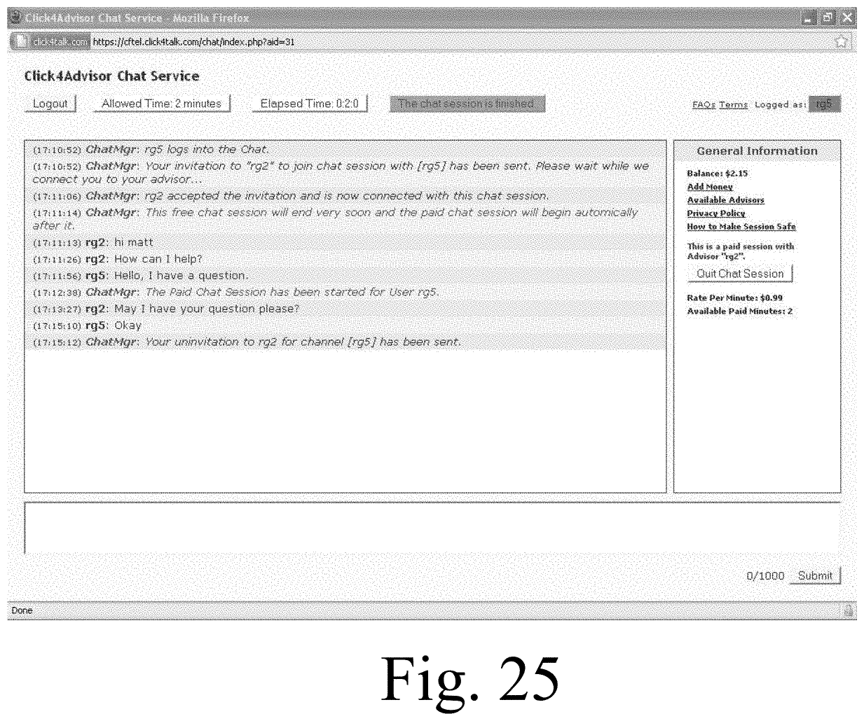

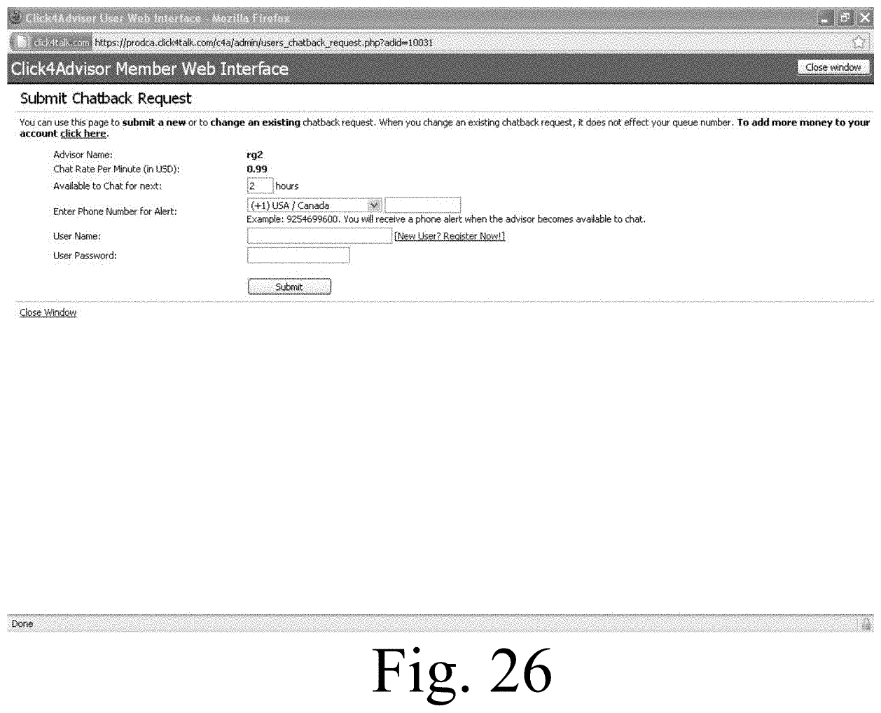

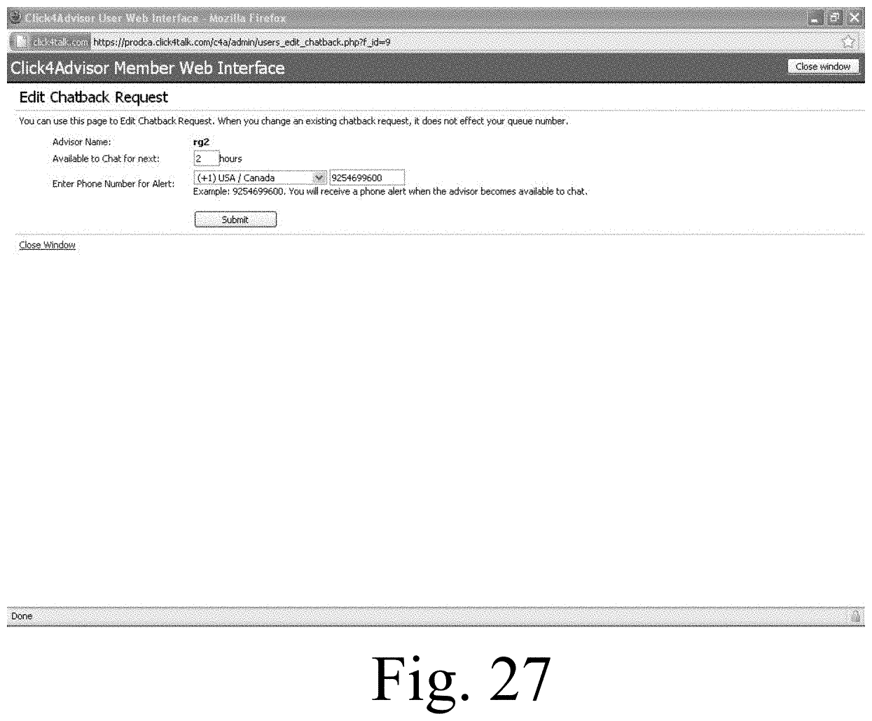

After a user submits a chat request 111, illustrated in FIGS. 26 and 27, a Service Provider is then notified 112 and accepts the request 112 and the parties are connected 113. The chat session is begun with the first two minutes, or any other predetermined time period, as a free, uncharged, chat session in step 114 and shown in FIG. 23. At the end of the time period, the free, uncharged chat session ends, and a paid session seamlessly continues the chat in step 115 illustrated in FIG. 24. Upon connection of the two parties, the system 1 uploads a real-time timer into the pop-up window, as shown in FIG. 5, visible to the User 10 which counts down the minutes until the User's account balance is depleted based on User 10 starting balance and the Service Provider's per-minute rate in step 118. If the User 10 stays connected to Service Provider 20 until their account is depleted, the system 1 will automatically terminate the chat session and/or prompt User to add more funds to the account in step 117. The system 1 updates the billing database for both the User 10, the Agent and the Service Provider 20 in real time upon the termination of a chat session in step 119 and illustrated in FIG. 25. During connection to a Service Provider, inventor's system will upload a busy message to any other user trying to connect to the service provider through the system in step 116.

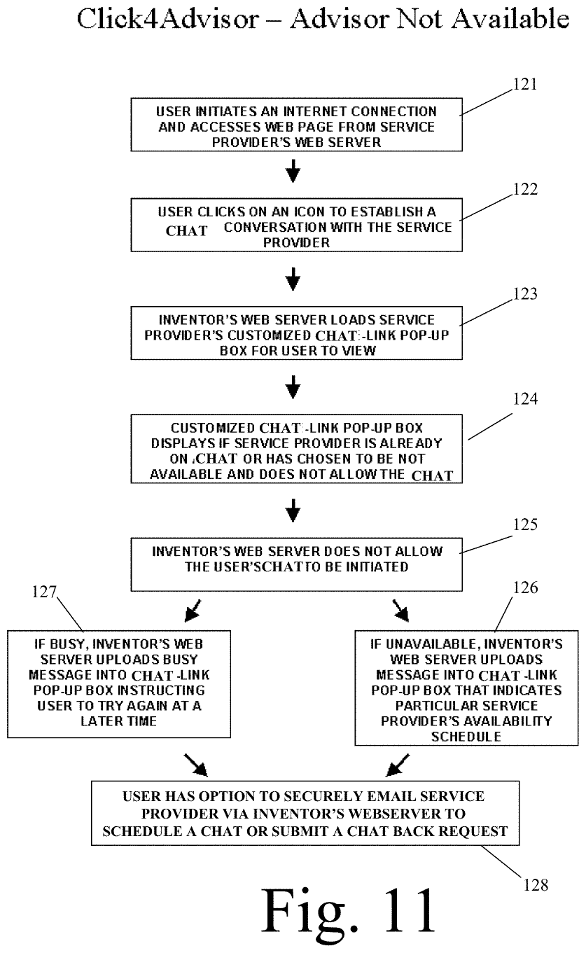

FIG. 11 displays a system flowchart of how the system 1 processes when a Service Provider 20 is Not Available. First, the User 10 initiates an Internet connection and accesses the Agent's website 300 or the Service Provider's web page or other web presence 200 from a web server in step 121. Next, the User 10 clicks on an icon to establish an online chat with the Service Provider 20 in step 122. The system 1 loads the Service Provider's standard/customized chat-link pop-up window from the system web server database 310 for User 10 to view in step 123. The system 1 checks the web server database 310 to determine whether the Service Provider 20 has pre-determined to be Not Available at this time and then with the communication interface 40 to determine if Service Provider 20 is already in a chat or otherwise unavailable in step 124. If either is the case, the system 1 does not allow the communications interface 40 to initiate the User's intended chat in step 125. Additionally, the web server 310 generates and displays in the standard/customized pop-up window that the Service Provider 20 is unavailable or has chosen to be Not Available at this time and that the User may Submit a Chat Request in step 127 or try again at a later time in step 126. The User 10 will then have the option to privately and securely submit a chat request to the Service Provider 20 via the system 1 to arrange an appointment in step 128.

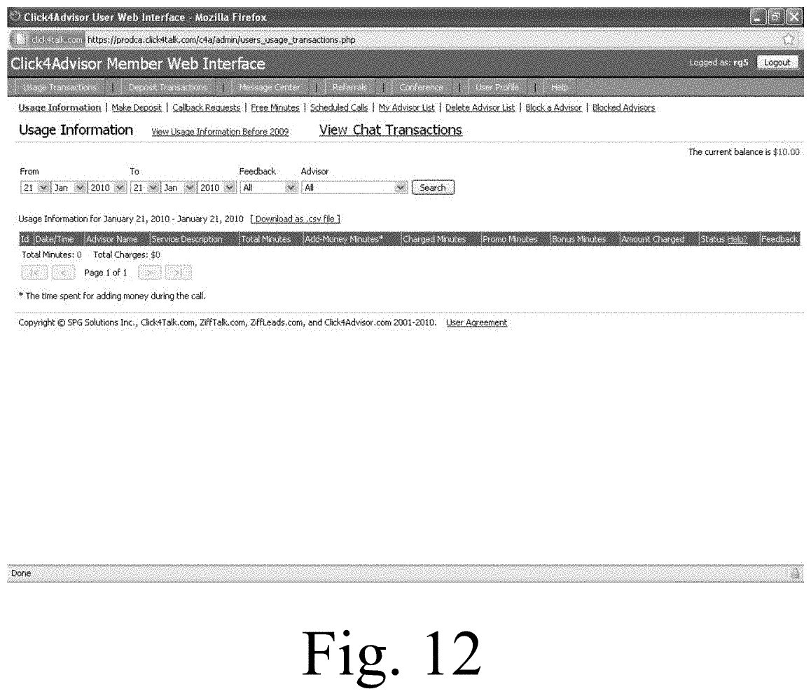

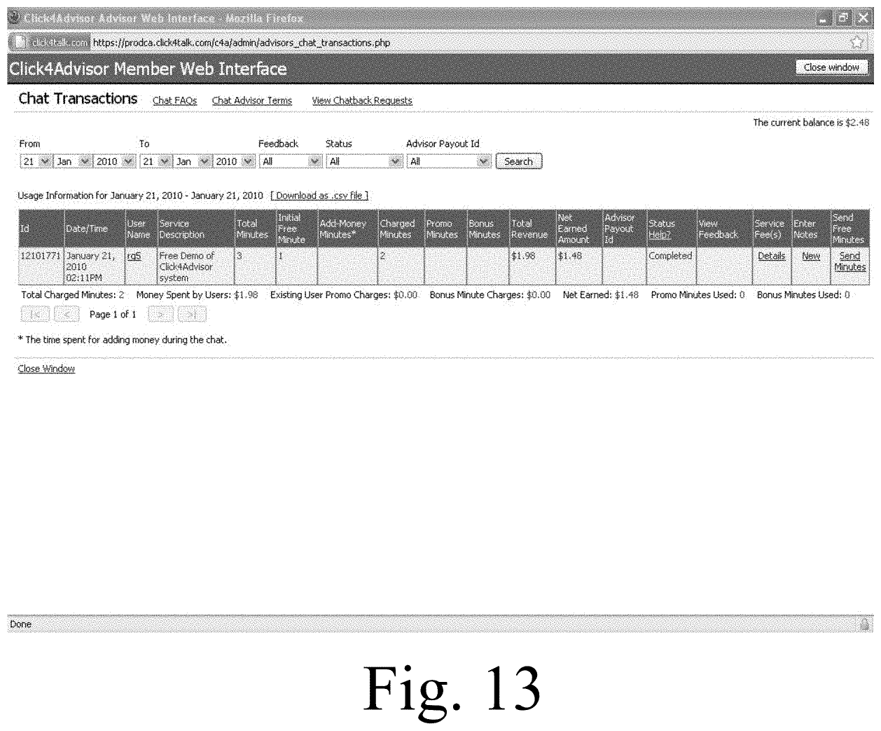

FIGS. 12 and 13 displays User 10 usage information from within the User management interface. The site 100 will ask for the Users 10 to enter their system name and password to access their account's User management interface. The system 1 will display this information to assist and inform the User 10. The web page will have the date/time, adviser's name and service description, chat duration, amount charged, the status, feedback and details. This information, along with many other account management functions within the User management interface, is used by the User 10 to manage his or her account. User-initiated deposits from the interface to the account of the User 10 initially and continually fund the account.

The system 1 will also create a feedback system for the Users 10 to reference based on a history of past feedback information on Service Providers 20 by other Users 10. The User 10 will give feedback to the system 1 regarding the Service Provider 20 based on the service provided. The system 1 will prompt a User 10 provide such feedback.

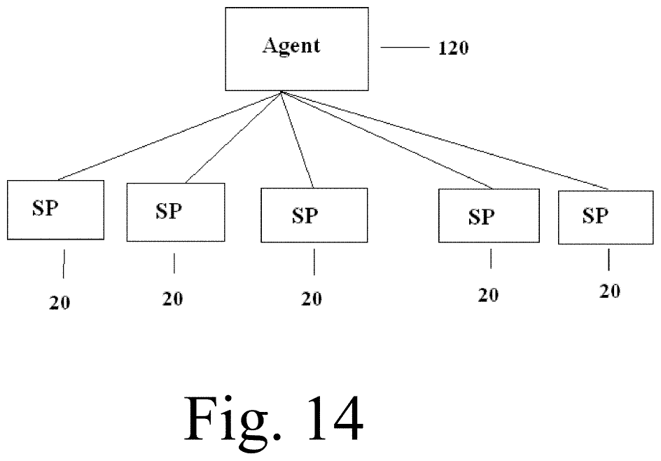

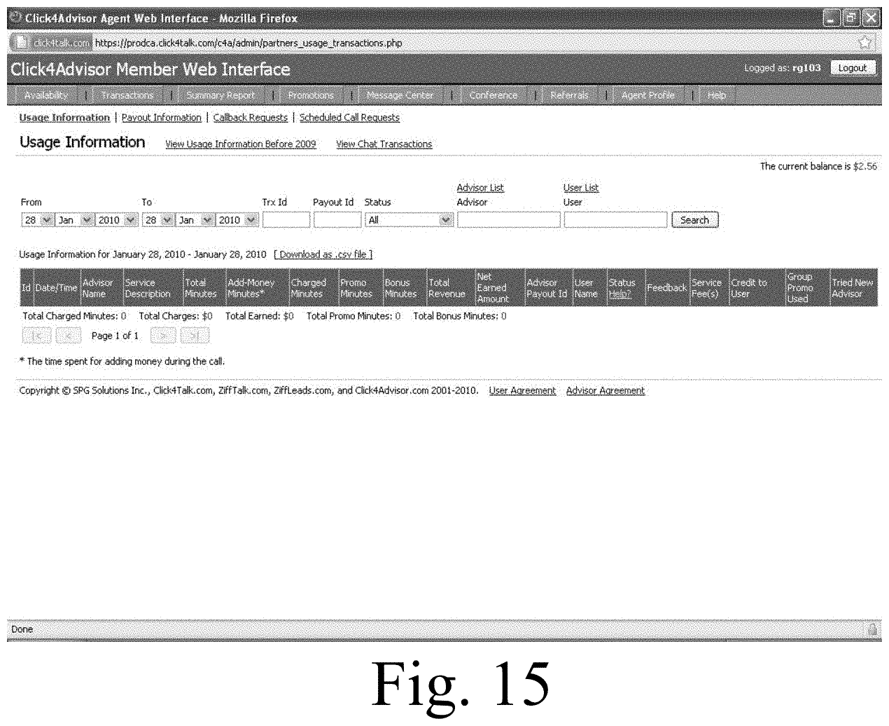

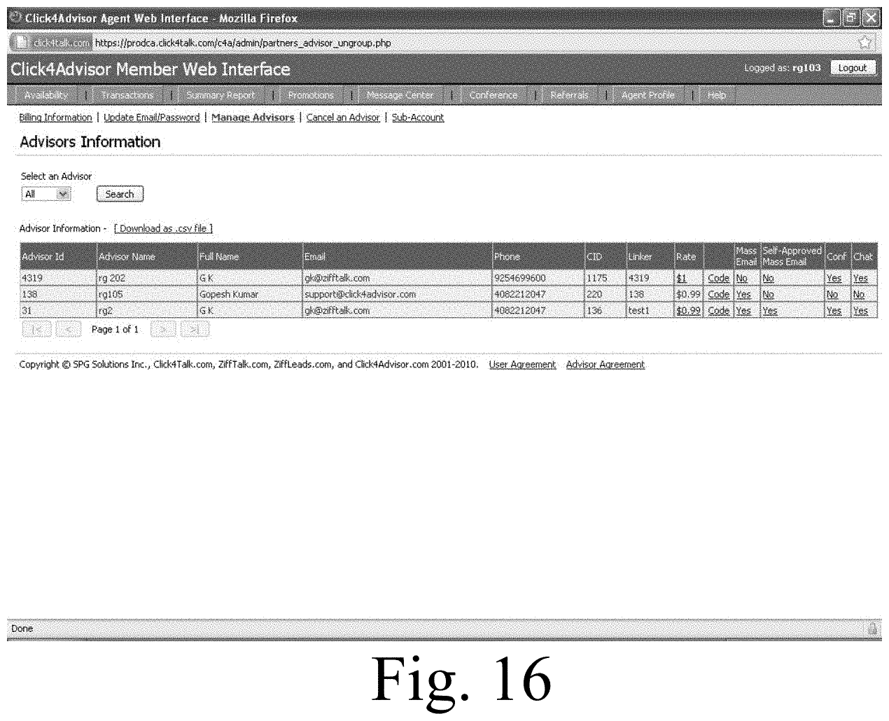

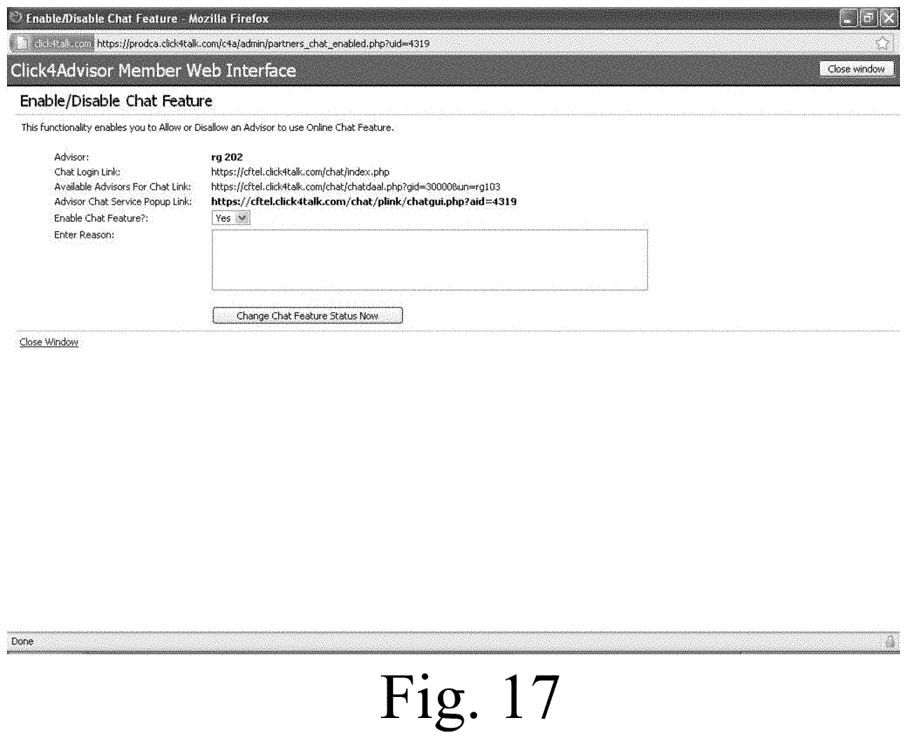

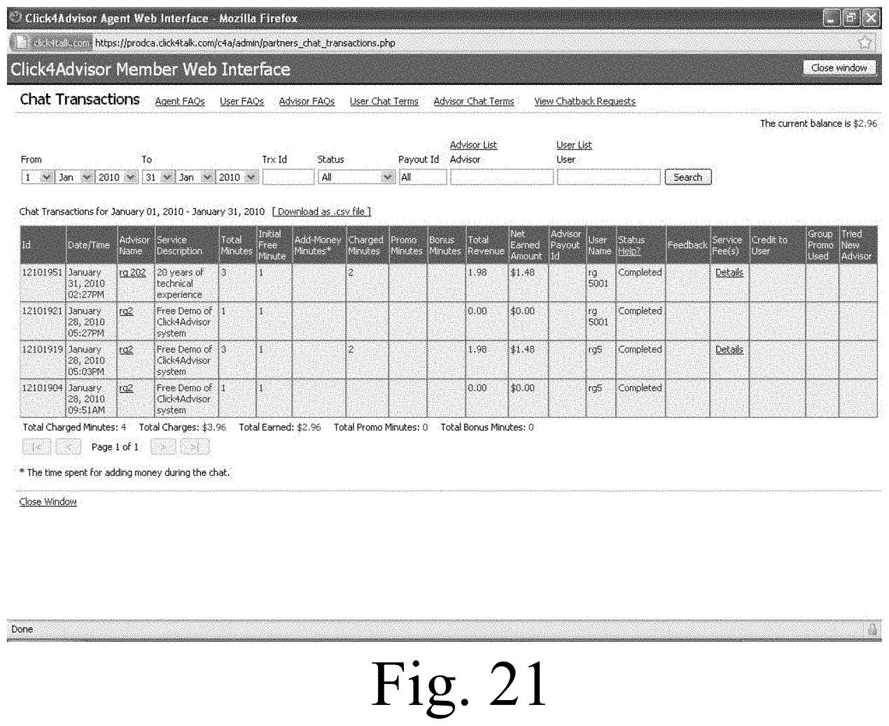

The system 1 will assign an Agent ID number to the Agent account. The expert Service Provider 20 will enter the appropriate Agent ID when registering as a new Service Provider 20 with the particular Agent in order to be displayed on the Agent's web site 300. As shown in FIG. 14, the system 1 will link all Service Providers 20 registered under a single Agent ID into one account information and transaction activity management interface: the Agent management interface. The system 1 will automatically distribute the appropriate service HTML code to the Agent for each newly registered Service Provider 20 thereby; enabling the Agent to readily create their own Internet-based collection of specialized Service Providers 20 and in turn, connect Users 10 with these Service Providers 20 for expert advice in real time via either a telephone connection or online chat service. FIGS. 15, 16, and 21 display a sample function of the system's 1 Agent management screen interface. As shown in FIGS. 15 and 21, Usage Information, the screen will have a transaction ID, the date and time of the transaction, service description, charged minutes, promo minutes, total revenue per transaction, Net earned amount, advisor payout ID, Username, status of transaction, service fee details and credit to user field that will be displayed. The screen will have selection criteria for the records to display. This criterion includes from and to dates, advisor payout ID, Service Provider and User. Additionally, an Agent can individually enable or disable a Service Provider as shown in FIG. 17. FIG. 21 displays a Chat Usage Transaction for an Agent page associated with an Agent.

The system 1 monitors how long chat connections are maintained between the Users 10 and the Service Providers 20. The system 1 will assist Agents who have multiple Service Providers 20 manage their transactions.

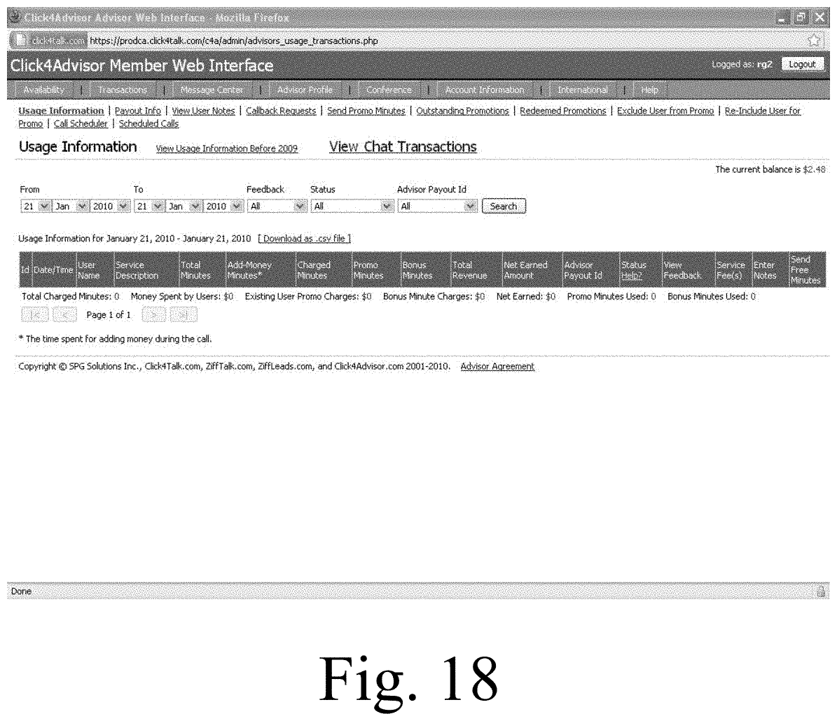

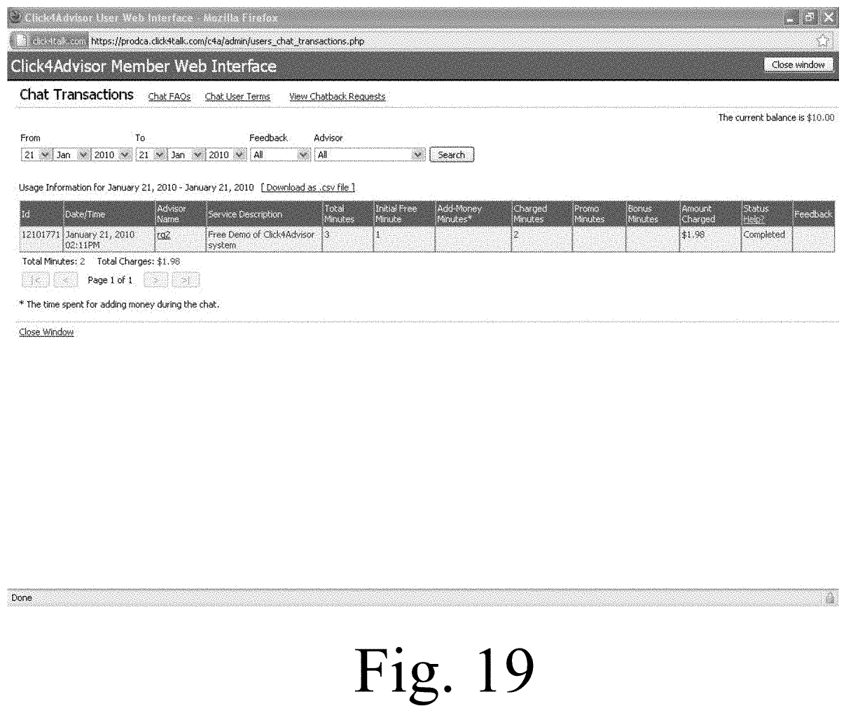

The system 1 will help an Agent manage their accounts by offering the Agent the option of automated payroll responsibility or a managed payout consisting of, deducting a pre-determined Agent service fee for each transaction and distributing the Agent fee to the Agent. The system 1, in the preferred embodiment, has a payout accounting screen, a sample shown in FIGS. 18 and 19, that displays the fees paid to the system per Service Provider 20 and a summary for the Agents based on their Service Providers' 20 transaction activity ands Users 10 based on their activity. The sample screen has the following fields: Date/Time, Payout ID, Service Provider/Agent description, payout method, Paid to, Amount and Detail. The screen will have a selection criterion for the records to display. This criterion includes from and to dates, advisor payout ID, Service Provider and User.

The system 1 will offer a number of payment options. The system 1 can either pay the Service Providers 20 directly for the Agent while also paying the Agent's service fee earnings to the Agent or pay the Agent the entire earned amount for the Agent Group, who in turn will then pay their Service Providers 20. The system 1 can handle all of the accounting and payment processing for the Agent for all or part of their associated Service Providers 20.

The system 1 provides a method and techniques for expert Service Providers 20, in turn, to provide their service through an unlimited number of Independent Agent web-based channels or websites 300 without potential communication device conflict for consumers.

The system 1 will offer recognition, across the entire database of Service Providers' including potentially multiple different accounts associated with multiple different Agent group web sites 300, or whether a particular Service Provider is busy and provide a busy notification 116. Thereby, enabling a Service Provider 20 to register and be part of numerous different Agent group web sites 300, without concern for any potential conflict.

The system 1 will keep track of the amount of time that the User 10 used an Agent's Service Provider 20 and use that time multiplied by the Service Provider's billable rate and the Agent's service fee to calculate the amount due to the Agent. The system 1 will manage all of the time and billing records for the Agent and their Service Providers 20. The system 1 will enter this information into a database.

The present invention allows Service Providers to offer chat sessions to Users who have a positive balance or the promotional free minutes in their account. All chat sessions shall be conducted over the Internet. The chat session will always be between a Service Provider and a User. The User information shall be kept confidential and shall not be disclosed to the Service Provider. After and Service Provider has chosen to enable the Chat Service on their Service Provider account, they will be provided with a link to embed in their website or Online advertising.

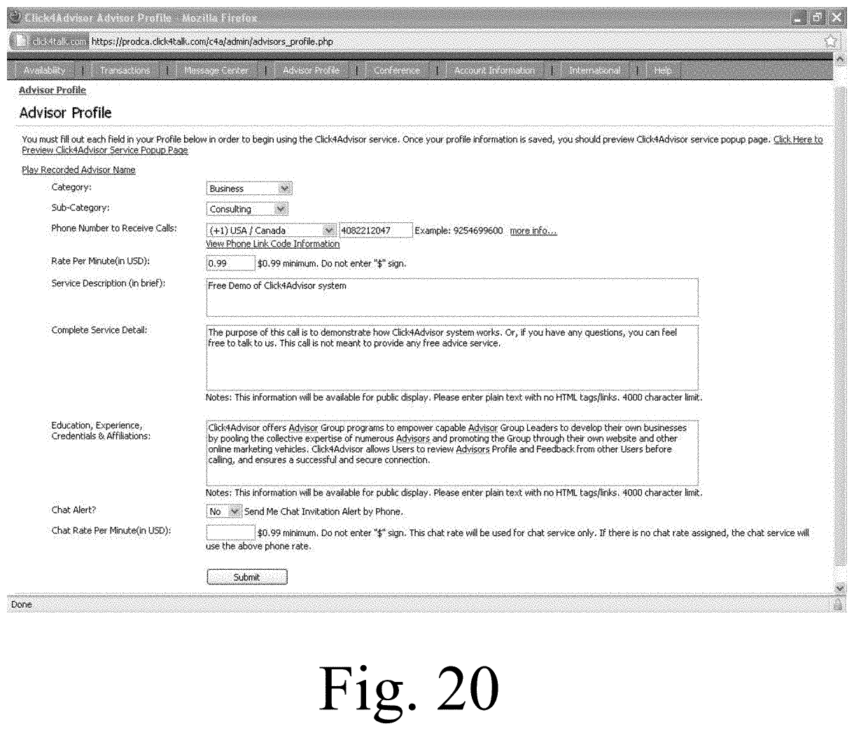

The price per minute for the chat session varies from Service Provider to Service Provider. Each Service Provider sets their individual per minute chat session rate in their profile as shown in FIG. 20. A User's balance will increase and decrease as you deposit funds and have ‘paid’ chat sessions. User's will only be able to have a chat session if they have a positive balance in their account with at least two (2) minutes of chat/talk time.

The price per minute varies from Service Provider to Service Provider. Each Service Provider sets their individual per minute chat session rate. The minimum chat session rate a Service Provider can set is $0.99 USD. An Service Provider can have different per minute rates for the chat service and the phone service. To change a Service Provider's rate, the Service Provider simply clicks on the “Service Provider Profile” tab and enter the new rate under “Chat Rate Per Minute”. If there is no chat rate assigned, the chat service will use the phone service rate.

When the chat session is in progress between User and Service Provider, they are shown as “Busy” so that they do not receive any one-on-one advice calls. Alternately, when a one-on-one session is in progress between User and Service Provider, they are shown as “Busy” so that they do not receive any chat session invitations.

If a Service Provider receives a chat session invitation and they DO NOT wish to chat, they simply decline the invitation. Once a Service Provider has declined a confirmation message will be displayed as well as a message will be sent to the User stating to try back later and/or to contact you using a one-on-one telephone advice link.

To view feedback from Users, regarding a Chat Session, a Service Provider logs in to their Service Provider account, clicks on the “Transactions” tab, and finds the Chat Session they want to view feedback on. On the far right of the display, there is a ‘View Feedback’ column. If the User has not provided feedback yet for the chosen chat session, within the allotted time frame, then the entry will show “Waiting”. Once the User submits the feedback, the entry will show ‘Submitted’ and the Service Provider can click on the ‘Submitted’ link to view feedback. Users can only submit feedback with respect to chat sessions, which they have attended. The feedback should be provided within seven calendar days of the paid non-promotional chat session of six minutes or longer with Advisors.

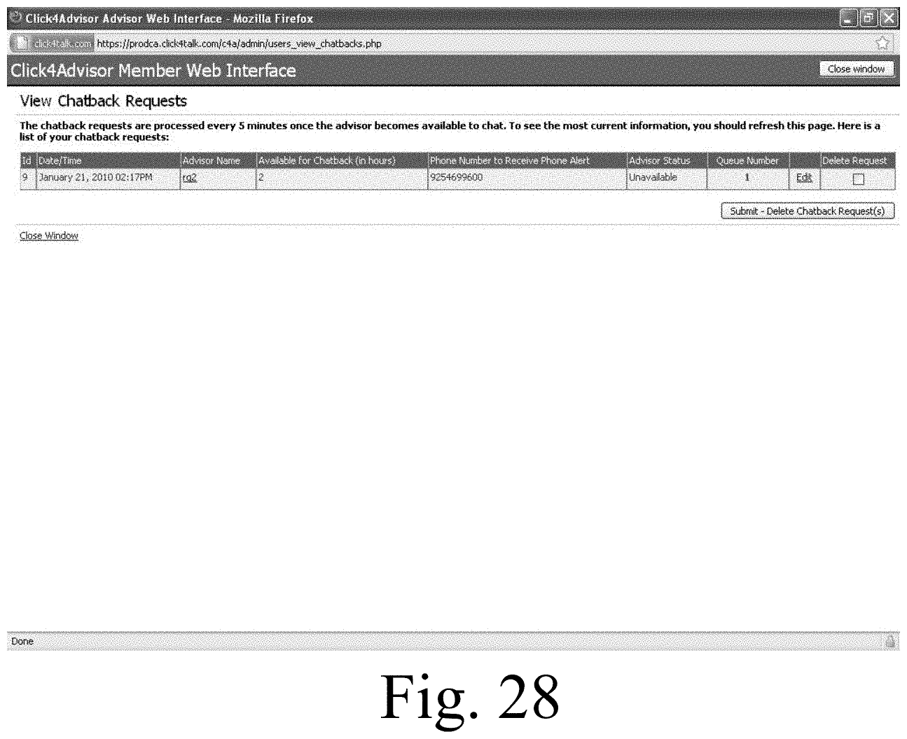

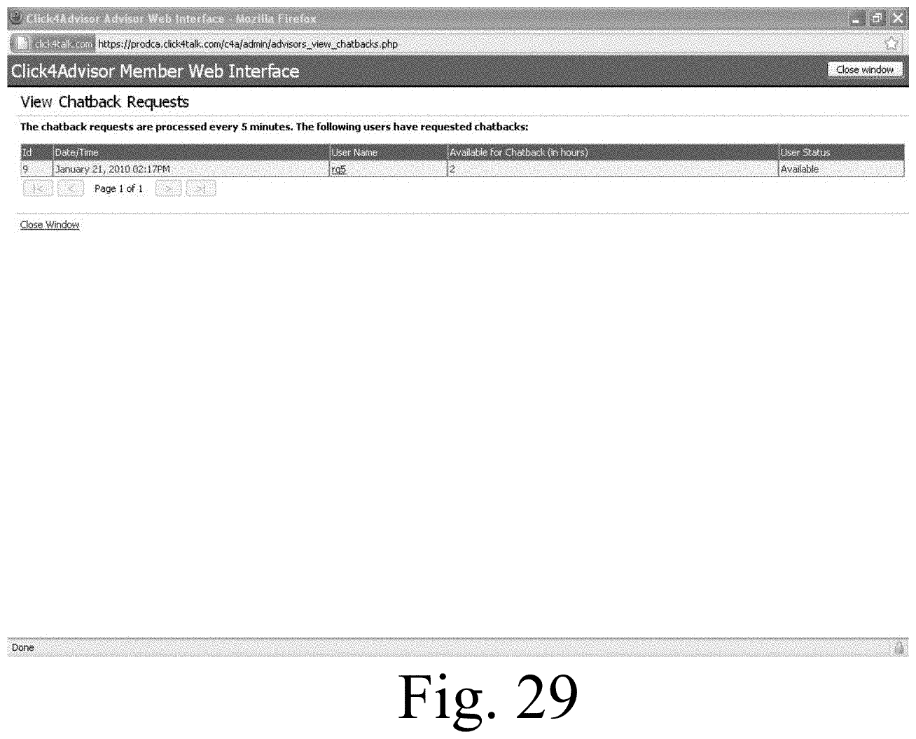

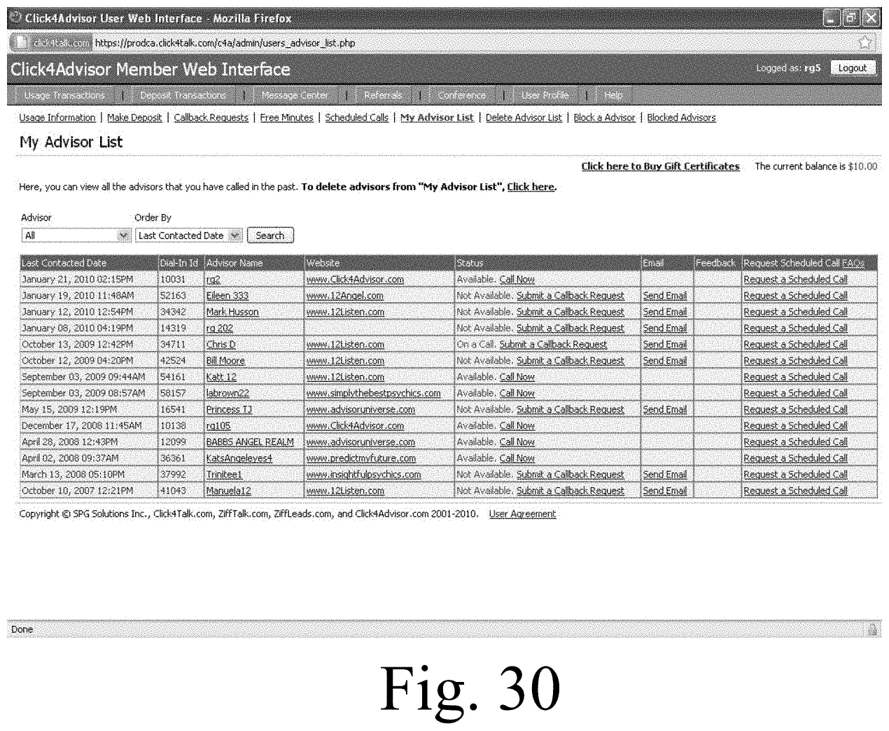

FIG. 28 shows a listing of User chat back requests. A user can enter a telephone number to receive a notification by phone when a Service Provider is ready and available for chat. Additionally, a User can request that the system send an electronic notice to them when a Service Provider is available for a chat. Electronic communications can be email, instant messenger, text, SMS, RSS, or any other electronic transmission. A User can also delete chat requests if they no longer require the service, but a Service Provider may only view chat requests submitted to him or her in the system as shown in FIG. 29. Finally, a User can review a list of all Service Providers they have contacted in the past. This history feature, shown in FIG. 30, provides many benefits to the User.

In an improved embodiment, the video chat service described hereafter is an extension to existing Text Chat service described above. Once the agent signs a Video Chat Service Addendum, the Agent page is enabled with Video Chat service. Now, the agent can enable any advisor in the agent's group for Video Chat service. As an agent, the agent first needs to navigate to manage Advisor pages and follow these steps: 1. Enable the advisor for Text Chat (click in Chat column), if they are already not enabled; 2. Now, enable the advisor for Video Chat (click in Video column); and 3. If the advisor wants to be available for video only and not text chat, you need to enable the advisor for “Video Only” (click in V-Only column). Note that step 3 is an optional step that is not required for the system to properly be executed and function.

The solution enabling the improved embodiment brings simplicity to login for video chat for both the advisors and the users. It makes training needs to the bare minimum. The video chat system releases the camera and microphone after getting the permission from advisor for availability and from user while sending the invitation message.

The permission granting serves multiple purposes such as: a) the advisors and users have working camera and microphone devices; b) the advisors and users are given appropriate messages in case the devices are not accessible or the permission is denied; c) In order to provide personal security, the advisors and users can view their background video and themselves before they give the permissions; and d) It protects advisors in receiving invitations from users who do not have video and microphone devices or deny permission to access them.

The video and microphone devices are actively engaged only after the advisor accepts the invitation. Before that the devices are free to engage for other uses by the advisors and users.

Once the advisor becomes available for video chat, the system provides the intelligence to user on advisor phone and chat service pages that the advisor is available for video chat. The dynamic buttons are displayed on advisor chat service page such as “Start Video Chat Session”. Similarly, the advisor phone service displays “Available for Video Chat”.

To enable an advisor for Video Chat is quite simple. Once the agent account is enabled for the Video Chat service, the agent interface becomes eligible to enable or disable advisors for the video chat. This empowers the agent to manage their advisors in providing the video chat service. The system has the real-time intelligence whether the advisor is enabled for the video chat or not.

Two chat requests have been added to the chat popup page: “Request an Immediate Chatback” & “Request a Scheduled Chat”. The Immediate Chatback feature works the same way as an Immediate Call Back Request for the phone system where customers can wait in queue for an advisor to sign on. Once a requested advisor signs on, the customer will receive a phone call notifying them the advisor is available for chat. The Schedule Chat links into the email system for customers to make personal appointments with their advisors.

Advisors can choose to have a phone call alert when they receive a chat invitation.

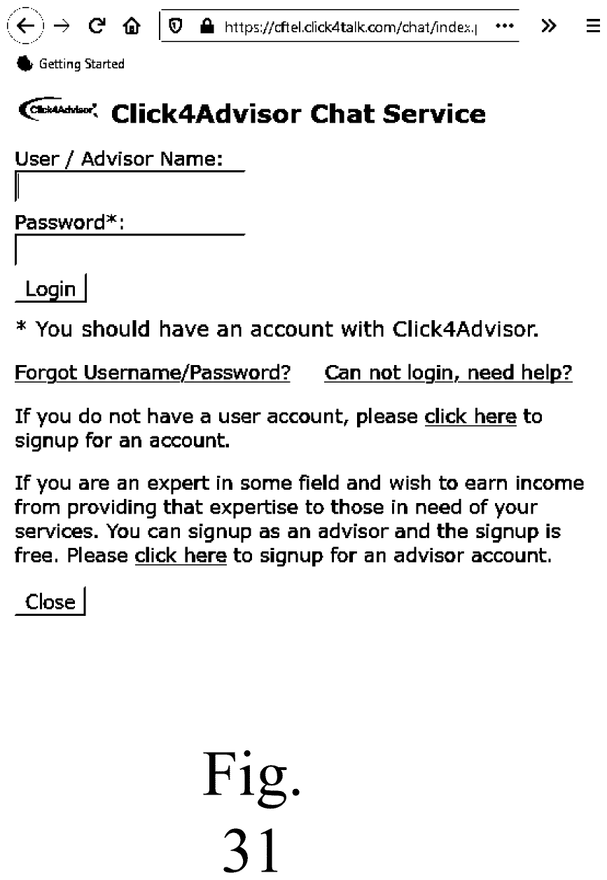

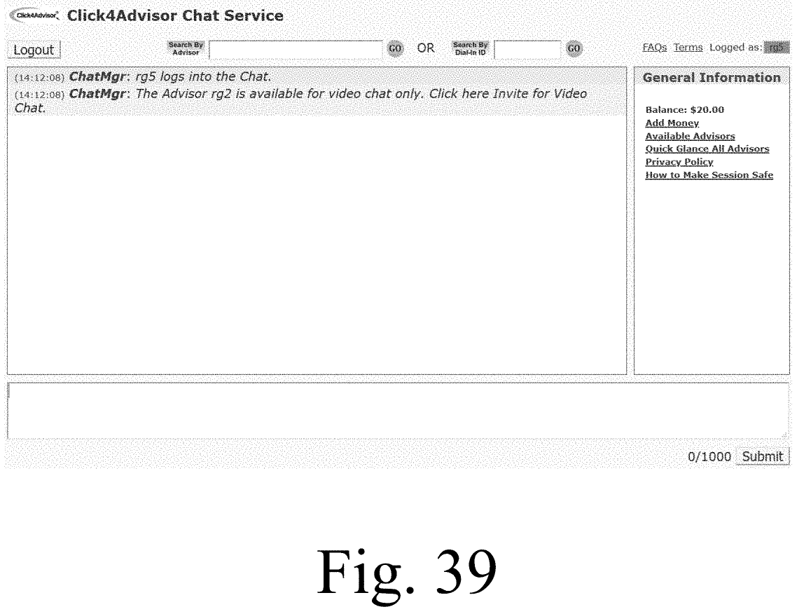

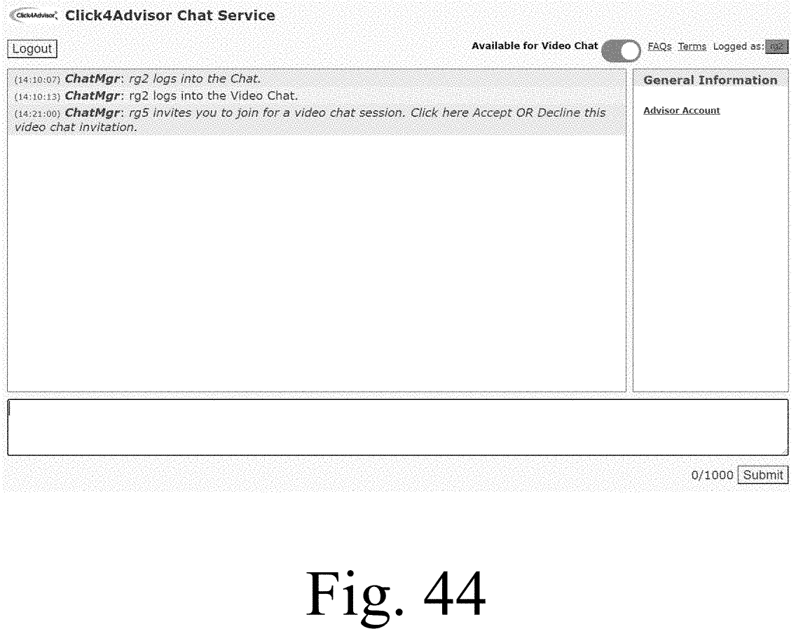

The video chat service of the improved embodiment works by first having an advisor needing to login into Text Chat service and then, click on “Available for Video Chat” button as shown in FIGS. 31-35. Next, when the user searches for an Advisor, the user can see whether the Advisor is available for a Video Chat or not inside their Chat interface and can invite the advisor for Video Chat. FIGS. 39 and 44 are the sample screens with “Video Only” (FIG. 39) and “Text Chat and Video Chat” both (FIG. 44).

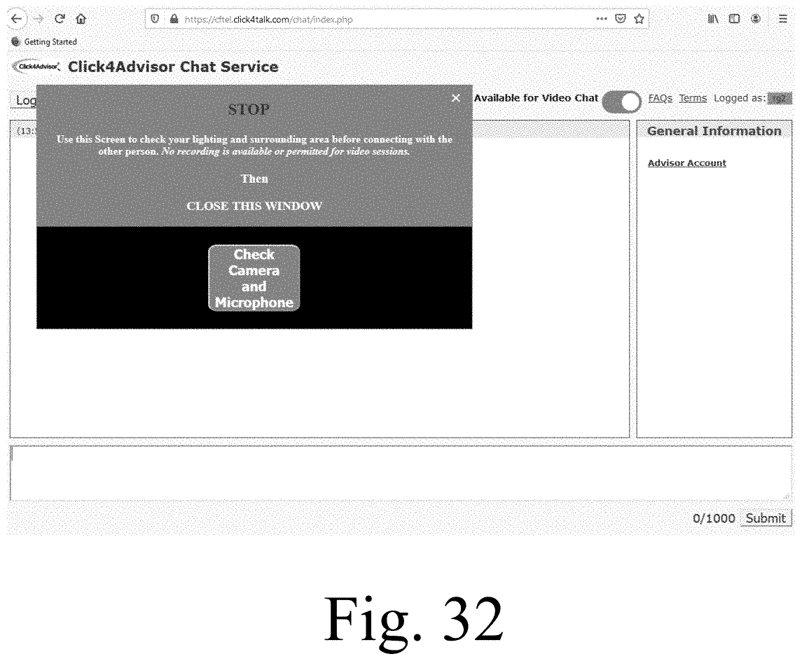

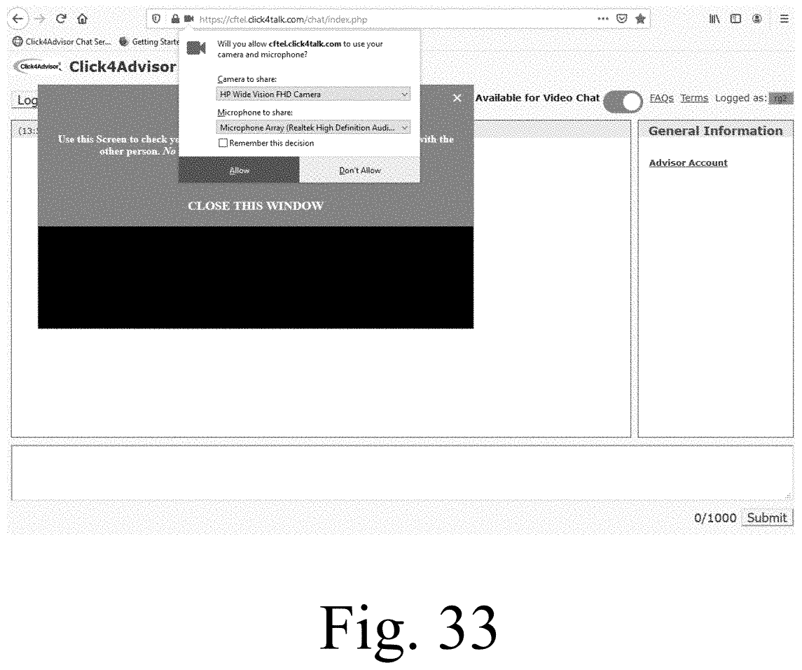

FIG. 31 shows a chat service login page where a user or advisor would enter their username and password to access their account and initiate a session. It is the same page for text chat too. After a successful login, the system presents the user or advisor with a quick camera and microphone check prompt and process where FIG. 32 shows an after chat login video popup page and FIG. 33 shows an advisor after chat login granting video permission. Once the advisor logs into the chat, the video popup page shows up as illustrated in FIG. 32 and the advisor grants permission for the video and microphone devices as shown in FIG. 33.

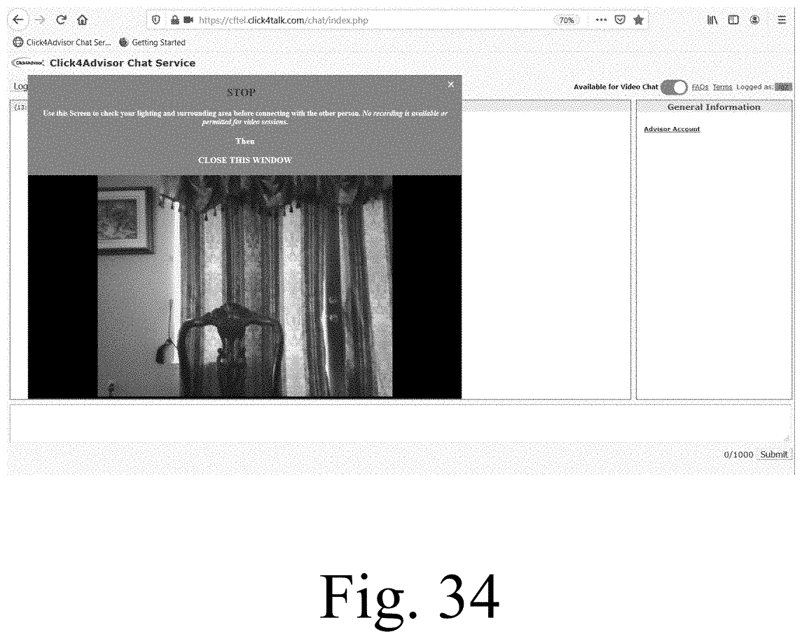

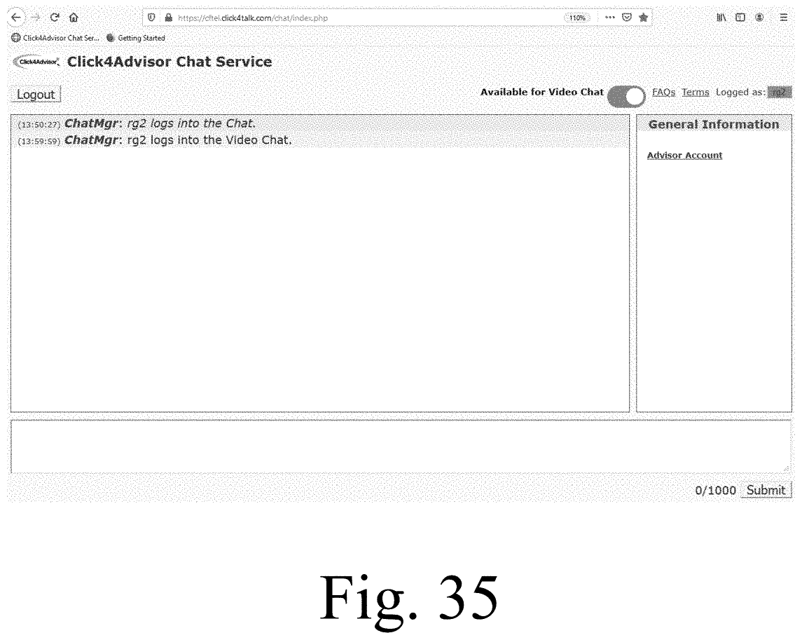

FIG. 34 shows an advisor after permission video review and FIG. 35 shows and advisor video login message. The Advisor reviews the video, background, and confirms by closing the window. The advisor sees the message “rg2 logs into the Video Chat” in the chat screen as show in FIG. 35. This message confirms to advisor that they are logged into the Video Chat. Once the advisor is logged into the video chat, the advisor phone service page shows the button “Available for Video Chat”.

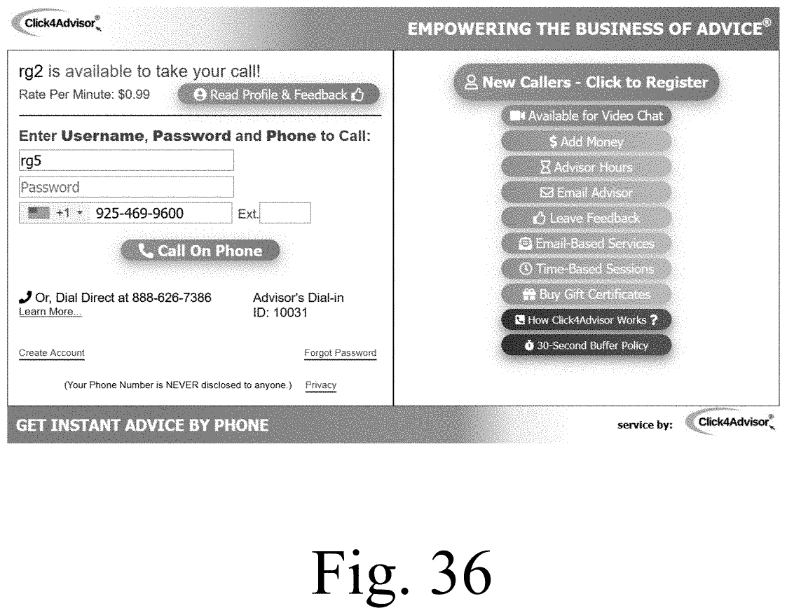

FIG. 36 shows and advisor call now service page where a user name and password login screen is presented and one or more options are presented in the right hand side of a two panel presentation such as: new user registration, notifying the system one is available for a video chat, adding money, checking or setting advisor hours, opening an email to an advisor, leaving feedback, accessing email based services, accessing time based sessions, buying gift certificates, and links to a how it works tutorial and a buffer policy. Additionally, FIG. 36 shows a chat button on top right “Available for Video Chat”. Once the user clicks on “Available for Video Chat” button, it shows the advisor chat service page.

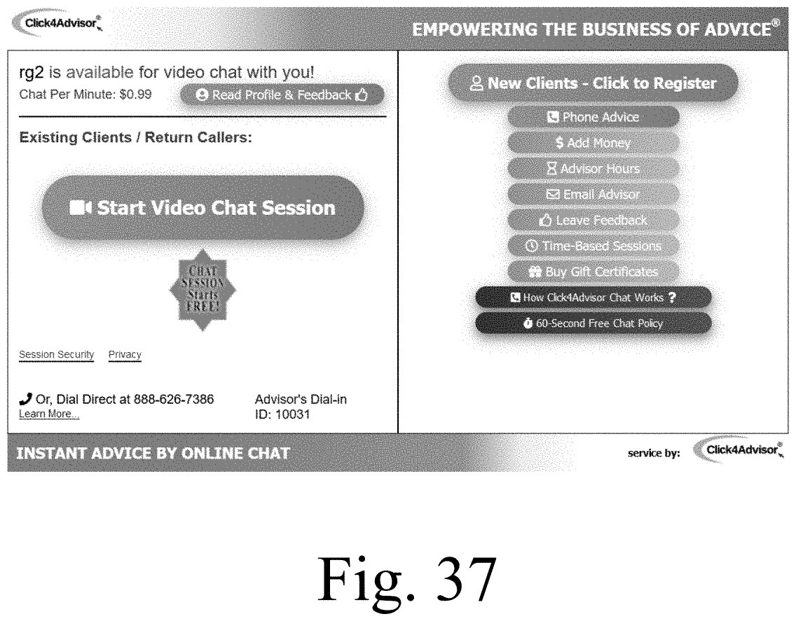

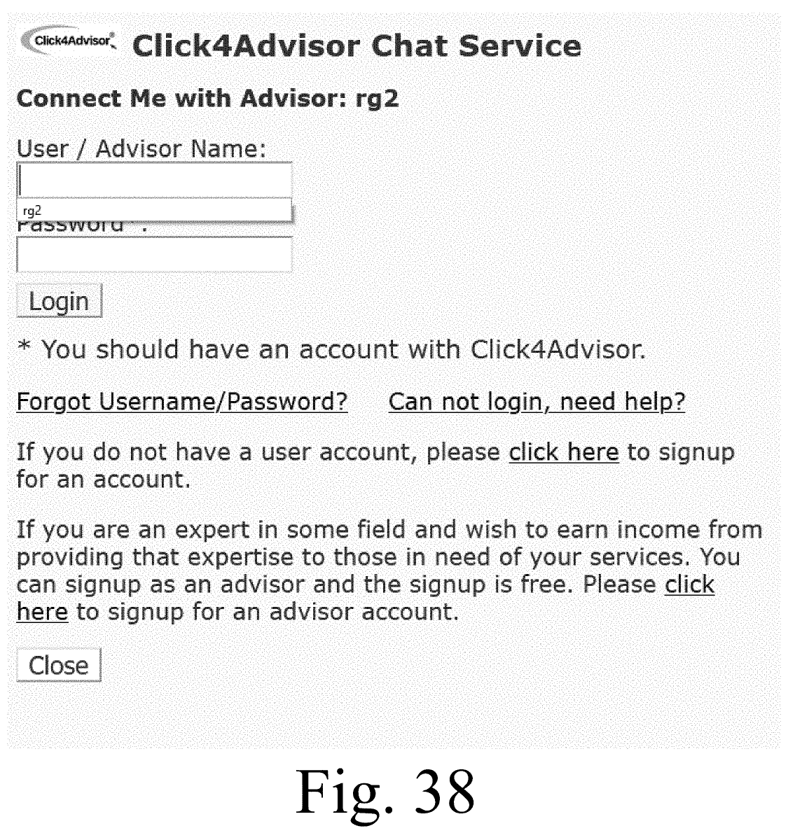

FIG. 37 shows and advisor video service page after an advisor has logged in. The same right hand side presentation as discussed and presented on the login page of FIG. 36, but now displaying if the advisor is available for a chat and the chat per minute cost. The advisor service video chat page shows the button “Start Video Chat Session” in FIG. 37 as well. Once the user clicks on “Start Video Chat Session” button, it shows the chat login page (FIG. 38) to user and upon logging into chat service, the user sees the Invite message to send to advisor. As shown in FIG. 39.

FIG. 38 shows a user chat login page from a video button, which again requests username and password entry for access. The chat login page for user shows that it carries the knowledge about advisor name. FIG. 39 shows a user screen after a login video invite message. The user sees the message in the chat screen. “The Advisor rg2 is available for video chat only. Click here Invite for Video Chat.” Once the user clicks on “Invite” to send invitation, the system prompts the user with video chat popup page.

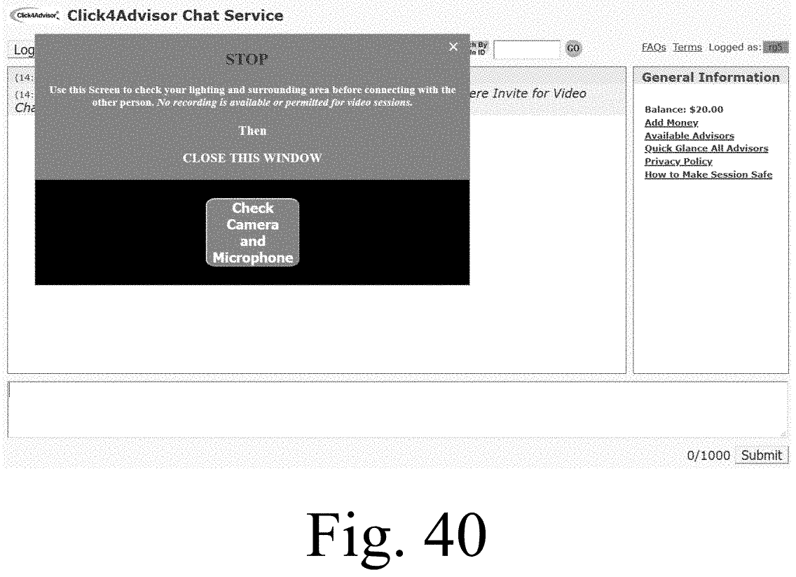

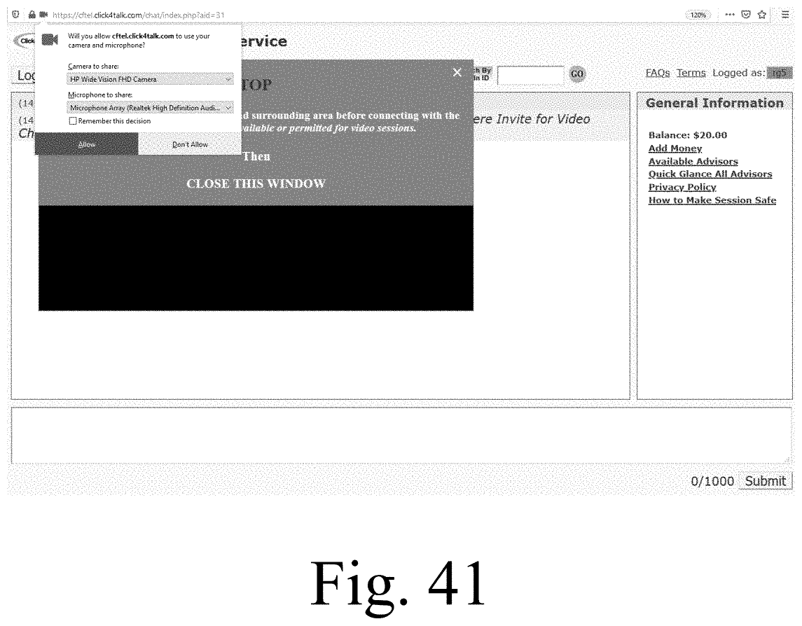

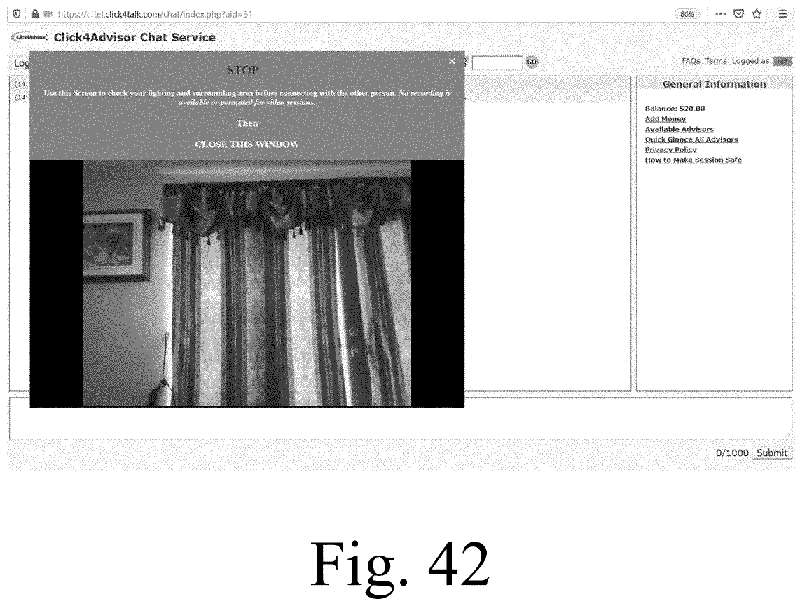

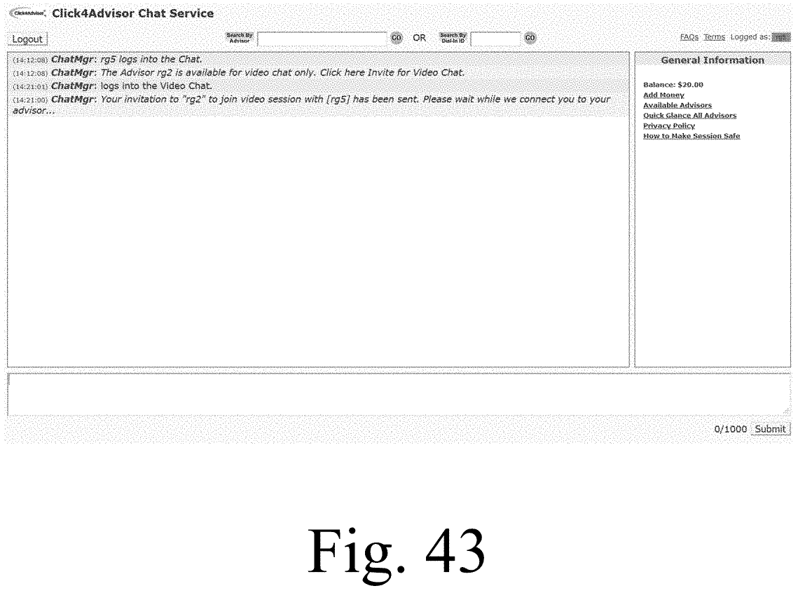

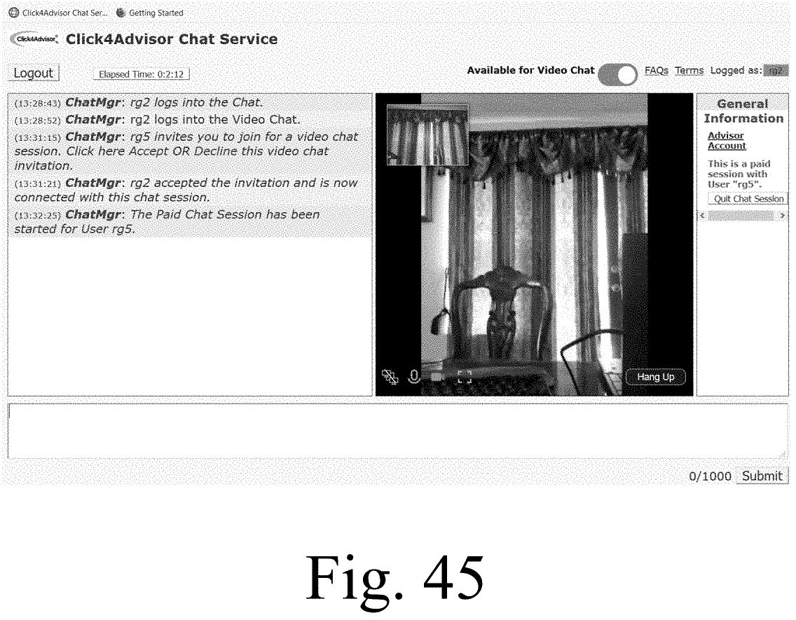

FIG. 40 shows a user after clicking invite video popup page. After a successful login, the system presents the user or advisor with a quick camera and microphone check prompt and process where FIG. 40 shows an after chat login video popup page and FIG. 41 shows a user screen after invite granting video per mission page. FIG. 42 shows a user after invite video view. and FIG. 43 shows a user chat screen after invitation message sent page. The user sees on the chat screen that the invitation has been send to the advisor. When the advisor clicks on Accept for video chat invitation, it connects both advisor and user immediately for video chat as shows in the FIG. 45.

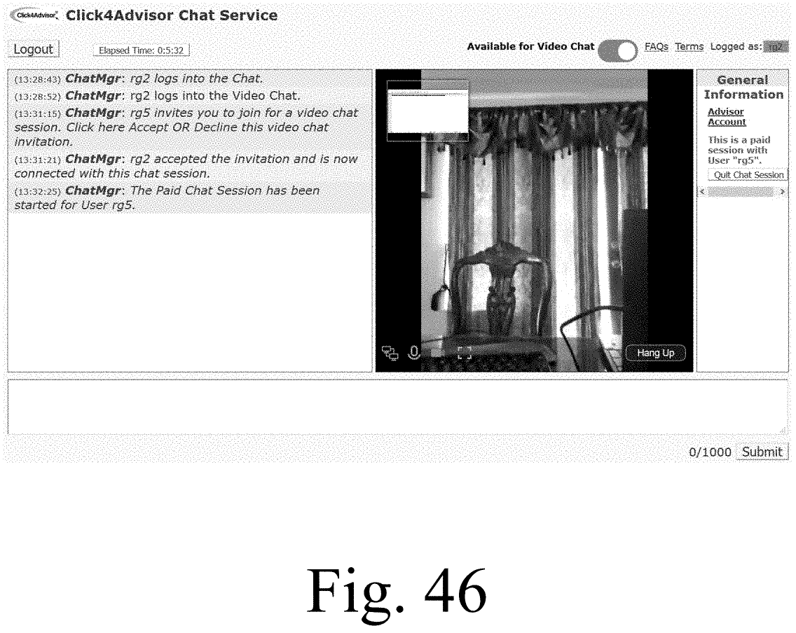

FIG. 44 shows an advisor with video invitation page where the user has requested a chat and the advisor can choose to accept or decline the video chat invitation. FIG. 45 shows a chat in progress after the users chat request has been accepted by the advisor. FIG. 46 shows a chat in process with a shared screen.

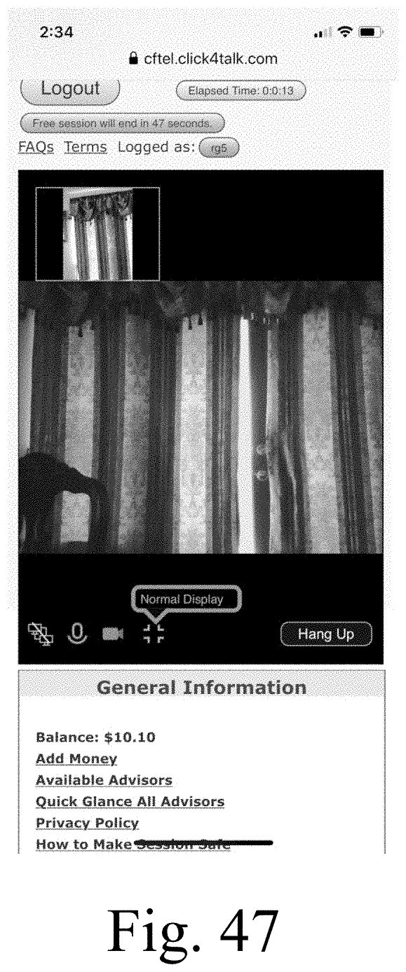

FIG. 47 shows a chat in progress with an expanded view in a shared screen embodiment and finally. Here, the figures illustrate an expanded video on iPhone (mobile device) and icon Text “Normal Display” is displayed when one hovers over the icon.

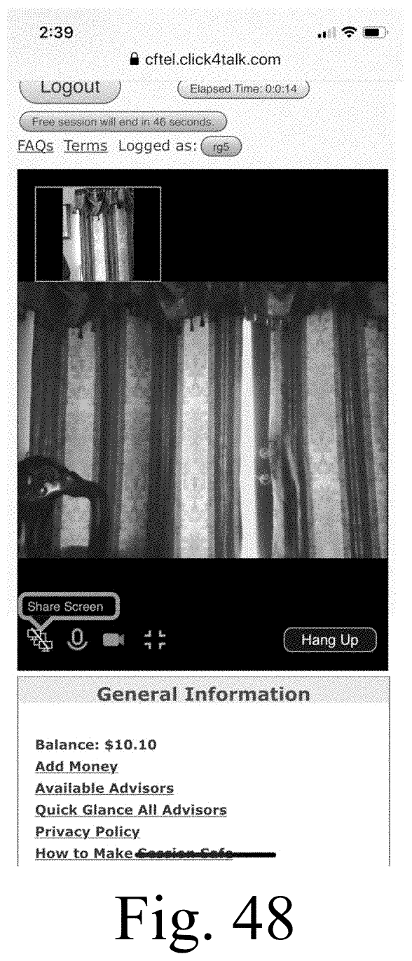

FIG. 48 shows a chat in progress with the share screen icon specifically noted for turning on and off the scared screen view between the parties. The icon text “Screen Share” is displayed when one hovers over the icon.

The system 1 is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system 1 can also be written in a number of different languages and run on a number of different operating systems and platforms.

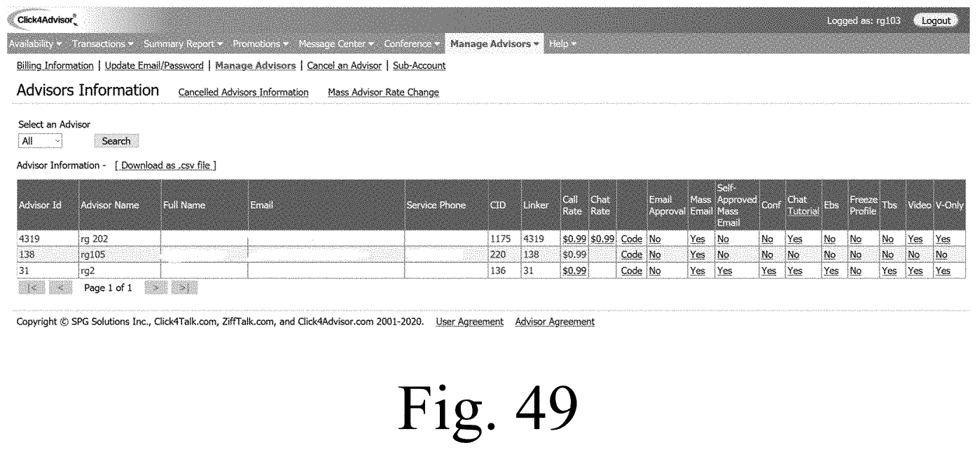

To summarize, the improved embodiment enables an agent to enable video chat services for their group of advisors. The agent can go in their interface and enable specific advisors for Video Chat. Also, they can enable these video chat advisors to conduct Video Only session and no text chat session. FIG. 49 shows an Agent's Manage Advisor page to enable an advisor for Video and V-Only which are represented by the two columns on the far right of the image.

Once the advisor is enabled for Video Chat, the service popup window now shows “Video Chat Advice” button or “Video/Text Chat Advice” button depending on whether the advisor is enabled for Video Only or not. In case of “Video Only” option, when the advisor logs into the chat service, the advisor is prompted to confirm availability for Video Chat and is suggested to review his/her video display. The system prompts to grant access to camera and microphone in order to become available for Video Chat. In case the advisor is offering both Video and Text Chat, the advisor logs into the chat service and has the option to become available for Video Chat by clicking on “Available for Video Chat” slider.

Once the advisor makes himself/herself available for Video Chat, the Chat Service page will display the “Start Video Chat Session” button or “Start Video/Text Chat Session” button depending on whether the advisor is enabled for Video Only or both Video & Text Chat.

Once the user clicks on “Start Video Chat Session” button, the user is prompted to login to chat service. Upon entering the valid login credentials, the chat screen displays in the Chat Screen the following line: “The Advisor rg2 is available for video chat only. Click here Invite for Video Chat.”

Once the user clicks on Invite link, the chat service sends a video chat invitation to Advisor. The system prompts the User to grant access to camera and microphone in order to be eligible to send invitation for Video Chat to Advisor. Upon closing the Video popup window, the system sends an invitation to Advisor with the following messages on the Advisor and User sides:

Advisor side message: USER invites you to join for a video chat session. Click here to Accept or Decline this video chat invitation.

User Side Message: Your invitation to “ADVISOR” to join video session with [USER] has been sent. Please wait while we connect you to your advisor.

Once the Advisor accepts the invitation by clicking on it, the Advisor and User are connected for online Video Chat over the Internet.

During the Video Chat Session between User/Advisor there are buttons available to Mute, Stop Video, Expand, Screen Sharing and Hangup the Video Chat: a) Mute button—Mute or Unmute the microphone; b) Stop Video button—stops or starts the video display; c) Expand button—expands the video display to full screen or shrinks it to display text chat window too; d) Screen Share button—it will replace the Video display with the Screen that the user or advisor wants to display; and e) Hangup button will terminate the video chat session.

The first period of time for free is one minute; and charging the User account balance for the online video chat session after the expiration of the fixed period of time. When the video chat session is in progress and there is one minute left for the video session to end, there is an audio announcement of “One Minute Left” message to both Advisor and User. The video session continues while the message is being played. Once the video chat session finishes, there is an audio message “Your video session is finished now” that is played to both Advisor and User.

Advisors choose to set a different rate for chat than for the phone service. If a rate is not entered, the chat will automatically use the current rate as selected in the phone service. The reporting for chat sessions has been streamlined with both the initial free minute and paid minutes as one line transaction entry rather than as two separate entries as seen during the previous demo.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of connecting two parties over an online chat in real time by using computer-readable medium and capable of execution by a computer, the method comprising:
having one or more Agents creating an associated selected plurality of one or more Service Providers;
enabling the Agents to integrate their selected plurality of Service Providers into their own specialized websites for browsing by a User;
having a User initiate a contact with a Service Provider via an Agent's specialized web site;
submitting a chat invitation by the User to the Service Provider if available;
initiating a pre-recorded phone alert if the Service Provider has opted to get a phone alert when a new chat invitation is received;
accepting the chat invitation by the Service Provider; and
connecting the User for a chat session with the Service Provider.

2. The method as described in claim 1, further comprising the step(s) of:
enabling an advisor for Text Chat, if they are already not enabled; and
enabling the advisor for Video Chat.

3. The method as described in claim 2, further comprising the step(s) of:
enabling the advisor for “Video Only”.

4. The method as described in claim 1, further comprising the step(s) of:
providing video chat service by:
having an advisor logged-in into Text Chat service;
having an advisor selected and listed as “Available for Video Chat”
processing a user's search query for an Advisor;
displaying to the user whether the Advisor is available for a Video Chat or not inside the user's Chat interface; and
enabling the user to invite the advisor for a Video Chat.

5. The method as described in claim 4, further comprising the step(s) of:
displaying a chat service login page where a user or advisor would enter their username and password to access their account and initiate a session;
after a successful login, the system presents the user or advisor with a quick camera and microphone check prompt and process;
granting video permission to the system by the user and advisor;
displaying an advisor after permission video review; and
displaying an advisor video login message.

6. The method as described in claim 5, further comprising the step(s) of:
displaying an advisor call now service page where a username and password login screen is presented, and one or more options are presented in the right hand side of a two panel presentation.

7. The method as described in claim 6, wherein one or more options are presented in the right hand side of a two panel presentation from the list comprising: new user registration, notifying the system one is available for a video chat, adding money, checking or setting advisor hours, opening an email to an advisor, leaving feedback, accessing email based services, accessing time based sessions, buying gift certificates, and links to a how it works tutorial and a buffer policy.

8. The method as described in claim 6, further comprising the step(s) of:
displaying an advisor video service page after an advisor has logged in and
displaying the same right hand side presentation; and
further displaying if the advisor is available for a chat and the chat per minute cost.

9. The method as described in claim 8, further comprising the step(s) of:
displaying a user chat login page from a video button, which again requests username and password entry for access;
displaying a user screen after a login video invite message;
displaying a user after clicking invite video popup page;
after a successful login, the system presents the user or advisor with a quick camera and microphone check prompt and process;
displaying an after chat login video popup page;
displaying a user screen after invite granting video per mission page;
displaying a user after invite video view; and
displaying a user chat screen after invitation message sent page.

10. The method as described in claim 9, further comprising the step(s) of:
displaying an advisor with video invitation page where the user has requested a chat and the advisor can choose to accept or decline the video chat invitation; and
displaying a chat in progress after the users chat request has been accepted by the advisor.

11. The method as described in claim 10, further comprising the step(s) of:
providing a toggle button or screen icon to the user and advisor allowing each part to individually control sharing their screen to the other party; and
displaying a shared screen to and between the user and advisor.

12. The method as described in claim 11, further comprising the step(s) of:
providing an expanded view in a shared screen embodiment.

13. The method as described in claim 1, further comprising:
connecting the User with the Service Provider;
providing online chat session free of charge for a first period of time; and
converting the online chat session to a paid service after the expiration of the fixed period of time.

14. The method as described in claim 13, wherein
the first period of time for free is one minute; and
charging the User account balance for the online video chat session after the expiration of the fixed period of time.

15. The method as described in claim 1, wherein
Advisors can choose to have a phone call alert when they receive a chat invitation.

16. The method as described in claim 1, wherein
Advisors choose to set a different rate for chat than for the phone service.

17. The method as described in claim 16, wherein
if a rate is not entered, the chat will automatically use the current rate as selected in the phone service.

18. The method as described in claim 16, wherein
The reporting for chat sessions has been streamlined with both the initial free minute and paid minutes as one line transaction entry rather than as two separate entries as seen during the previous demo.

19. The method as described in claim 1, wherein
when the video chat session is in progress and there is one minute left for the video session to end, there is an audio announcement of “One Minute Left” message to both Advisor and User; and
the video session continues while the message is being played.

20. The method as described in claim 1, wherein
once the video chat session finishes, there is an audio message “Your video session is finished now” that is played to both Advisor and User.
